(19) United States
(12) Patent Application Publication
(10) Pub. No.: US 2026/0349968 A1
(43) Pub. Date: Nov. 5, 2026

(54) Computer System, Computer-Implemented Method, and Computer Readable Media for Negotiating and Executing Interactive Processes With Data Input Mechanisms

(71) Applicant: Shopify Inc., Ottawa (CA)

(72) Inventors: Mani FAZELI, Toronto (CA); Ilya GRIGORIK, Portland, OR (US)

(73) Assignee: Shopify Inc., Ottawa (CA)

(21) Appl. No.: 19/295,764

(22) Filed: Aug. 11, 2025

Related U.S. Application Data
(60) Provisional application No. 63/798,028, filed on May 1, 2025.
(60) Provisional application No. 63/811,976, filed on May 26, 2025.

(51) Int. Cl. G06F 16/21; H04L 67/02

(52) U.S. Cl. CPC G06F 16/211; H04L 67/02

(57) ABSTRACT

A system and method are provided for negotiating and executing interactive processes with data input mechanisms. The method includes receiving, at a first AI agent via a communication channel, a request to complete an interactive process with a structured or semi-structured data input mechanism. The method also includes inspecting, by the first AI agent using an LLM, the data input mechanism for interaction elements usable in the interactive process to provide input; generating, by the first AI agent using the LLM, based on the interaction elements, an input schema for one or more tools invokable by the first AI agent that are capable of determining inputs to provide using the interaction elements; and providing, by the first AI agent, the input schema via the communication channel, to have the one or more tools invoked to have the interaction elements completed.

### CROSS-REFERENCE TO RELATED APPLICATIONS

This application claims priority to U.S. Provisional Application Nos. 63/798,028 filed on May 1, 2025; and 63/811,976 filed on May 26, 2025, the entire contents of which are incorporated herein by reference.

### TECHNICAL FIELD

The following relates generally to data input mechanisms and, in particular, to negotiating and executing interactive processes with such data input mechanisms.

### BACKGROUND

Existing data input mechanisms, whether structured or semi-structured, may rely on multiple manual interactions. Such manual interactions may have entities enter requested data and information to complete an interactive process. While autofill or single-click approaches exist to complete data input mechanisms such as webforms, these approaches typically presume static, preconfigured data.

### BRIEF DESCRIPTION OF THE DRAWINGS

Embodiments will now be described with reference to the appended drawings wherein:

FIG. 1a is an example of a computing environment in which a computer-implemented artificial intelligence (AI) agent is utilized to interact with a data input mechanism such as a web page.

FIG. 1b is an example of a computing environment in which first and second AI agents are used to interact with a data input mechanism.

FIG. 2a is an example of a configuration for using an interaction engine to invoke one or more tools for the environment shown in FIG. 1a.

FIG. 2b is an example of a configuration for using an interaction engine to invoke one or more tools for the environment shown in FIG. 1b.

FIG. 3a illustrates a server-client agent architecture.

FIG. 3b illustrates the architecture of FIG. 3a deployed on a local system connected to a remote server.

FIG. 3c illustrates the architecture of FIG. 3a deployed between a local system and a remote server.

FIG. 3d illustrates the architecture of FIG. 3a deployed on an agent provider interposed between a local system and a remote server.

FIG. 4 is an example of a configuration for implementing the interaction engine.

FIG. 5 is an example of a computing device operable to be utilized in the computing environment.

FIGS. 6a, 6b, and 6c are sequence diagrams illustrating a process for negotiating and executing interactive processes with data input mechanisms.

FIGS. 7a and 7b illustrate a user interface having an interactive webform with an automated completion.

FIGS. 8a, 8b, 8c, and 8d illustrate a user interface having an interactive webform with a prompt for manual input and a prompt for manual submission.

FIG. 9 is a flow chart illustrating example operations for negotiating and executing interactive processes with data input mechanisms.

FIG. 10 is a flow chart illustrating example operations for a first AI agent obtaining inputs to be entered into interaction elements.

FIG. 11 is a flow chart illustrating example operations for determining completion of an interactive process.

FIG. 12 is a flow chart illustrating example operations for obtaining an input from an entity other than the AI agent.

FIG. 13 is a flow chart illustrating example operations for updating an input schema based on changes to a web page.

FIG. 14 is a flow chart illustrating example operations for entering updates based on input received according to an updated input schema.

FIG. 15 is a block diagram of a simplified convolutional neural network, which may be used in examples of the present disclosure.

FIG. 16 is a block diagram of a simplified transformer neural network, which may be used in examples of the present disclosure.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

Data input mechanisms such as webforms have been found to lack accommodation for real-time dynamic requirements or new information requests that may arise when completing an interactive process to provide data information to the webform. There is a need for a mechanism enabling a delegated agent (or agents) to dynamically discover, negotiate, and satisfy provider-imposed requirements to enter data and information in a data input mechanism, at least in part in the background. The proposed solution provides a system to enable an AI agent to use dynamic interactive processes and workflows using examination techniques such as introspection, and update an input schema for a set of tools. While certain examples described herein refer to the applicability of the described system to web pages and webforms, the principles discussed herein equally apply to any structured or semi-structured data input mechanism.

Taking an example applied to a web page used to complete an interactive process such as a checkout, required fields and steps may change based on user input (e.g., country selection adding a province field) or specific provider configurations (e.g., add-on processes, ID verification, etc.). As such, agents may need to adapt in real-time. Software (e.g., implemented as a server, Chrome extension, or on a checkout server) may examine the checkout web page by inspecting its Document Object Model (DOM), extracting some or all form fields and their semantic/contextual information (e.g., accessibility tags). The system may translate each form field (or logical group of fields, like a full address) into an input schema for a number of “tools”— application programming interface (API)-like actions or structured objects that the AI agent can use to input data or interact with the checkout form. The input schema and list of tools may be built automatically and kept current with the state of the form. It can be appreciated that while some implementations may utilize a dynamically changing input schema for a set of tools, in other implementations, a dynamic list of tools may be utilized where the list of tools changes and tools may be configured to be mapped to form fields.

The proposed solution thus enables AI agents (e.g., powered by LLMs) to dynamically examine and interact with web page elements to minimize or even eliminate the need to interact with an entity attempting to complete an interactive process. The dynamic interactions may utilize static or dynamic tool sets that are defined using input schema that may also be dynamically updated during the process. This may include dynamic feedback loops in which new states are detected, incomplete data is detected, new schemas are generated, and the feedback loop initiated and repeated as necessary to converge on a completed process (e.g., completed form for submission). The agent used to interact with the web page may utilize various inspection techniques, including DOM introspection, Accessibility Tree introspection, APIs, or other interfaces made available to the agent. When utilizing multiple agents, the agents may communicate with each other using a suitable communication protocol, including without limitation, a context-based protocol such as the Model Context Protocol (MCP).

The system may recognize when the process (e.g., form) is “complete” and be configured to automatically proceed (e.g., click “buy”) when possible. If full automation is not possible, for example, due to legal/regulatory requirements or to resolve unknown inputs, the system may prompt the user in various ways, with an aim to obtain the minimum required or necessary. For example, the system may prompt the user to obtain data for an unknown input and have them fill out this information. The system may prompt the user to obtain a confirmation for a known input that has been filled out but requires such confirmation. The system may not need to prompt the user if the input is known and is automatically completed. In such cases the user may be notified of any such auto-completions.

Certain browsers and password managers may have been found to only autofill specific, static fields and may not autonomously complete entire, often-dynamic web forms. Similarly, such browsers and password managers have been found to not include capabilities to interpret arbitrary forms or complete a full set of possible choices. Here, the system may approach an interactive process more generally, namely by inspecting the data input mechanism, e.g., a live DOM in the case of a web page; and generate an up-to-date, tool-based input schema interface for AI agents and LLMs to fully execute checkout, and handle dynamic or conditional form fields. The input schema, tool abstraction, and agent-to-agent protocol (possibly on both the client and server side) allow complete end-to-end, AI-driven, zero-click completion (e.g., for checkout, submission), even as forms change or decisions are needed.

The system may allow third-party AI agents to perform automated transactional processes for users that seamlessly, using generalizable, robust web form interaction, facilitate a “zero-click” checkout/completion implementation. The system may implement a protocol-agnostic communication framework for interactions between an agent and dynamic web-form provider, which may be embedded or remote. The system enables a software agent to negotiate web-form processes (e.g., a complex checkout) on a user's behalf by establishing a standardized communication channel between the user’s agent and checkout/web-form interface, discovering available web-form actions through a semantic tool interface, programmatically submitting user data and preferences, receiving real-time notifications about webform state changes, adapting to dynamically changing web-form requirements using updated input schema, and performing automated submission.

Once all requirements are satisfied, the agent may complete the webform (e.g. complete transaction or submission) on behalf of the requesting entity (e.g., user interacting with a user interface), enabling a zero-click experience that may, in at least some workflows require no further direct user engagement unless explicitly needed by a particular workflow.

The system described herein may enable truly frictionless (e.g., zero click) interactive process experiences by allowing AI agents to programmatically complete the interactive processes (e.g., checkout or other form submission) on behalf of a user while adapting to the dynamic and complex nature of modern interactive process flows. A standardized protocol may be used to ensure interoperability across different providers and data input systems. For example, the system described herein may provide dynamic discovery and negotiation where requirements can change as the interactive process detects new constraints or fields needed and the AI agent(s) automatically adapt and resubmit data. The system may also provide extensibility and scalability such that the protocol can support local and remote providers, and dynamically adapt to many (e.g., millions) of different interactive configurations configured by different providers. The system may additionally reduce user burden since the user may not be required or prompted to intervene unless deemed necessary by the particular process, user, scenario, etc. If and when a user is asked to intervene or provide direct input, the state of negotiation may not be lost and automated negotiation may be resumed.

In one aspect, there is provided computer-implemented method comprising receiving, at a first computer-implemented AI agent via a communication channel, a request to complete an interactive process with a structured or semi-structured data input mechanism; inspecting, by the first AI agent using an LLM, the data input mechanism for interaction elements usable in the interactive process to provide input; generating, by the first AI agent using the LLM, based on the interaction elements, an input schema for one or more tools invokable by the first AI agent that are capable of determining inputs to provide using the interaction elements; and providing, by the first AI agent, the input schema via the communication channel, to have the one or more tools invoked to have the interaction elements completed.

In certain example embodiments, the further includes receiving, by the first AI agent, via the communication channel, inputs to be entered into the interaction elements; and entering, by the first AI agent, the inputs into the interaction elements of the data input mechanism.

In certain example embodiments, the method further includes determining, by the first AI agent, that the interactive process has been completed; and having, by the first AI agent, an action executed in response to completion of the interactive process.

In certain example embodiments, the method further includes determining, by the first AI agent, that at least one operation in the interactive process requires an input from an entity other than the first AI agent; and initiating, by the first AI agent, a process to obtain the input from the entity.

In certain example embodiments, the input from the entity includes obtaining confirmation of completion of a submission.

In certain example embodiments, the input is obtained via a user interface operable to utilize the first AI agent.

In certain example embodiments, the input schema defines inputs to be determined using one or more tools from a set of tools.

In certain example embodiments, the input schema provides a mapping to a dynamic set of tools capable of determining the inputs.

In certain example embodiments, the request is received from, and the input schema is provided to, a second AI agent.

In certain example embodiments, the second AI agent utilizes an LLM.

In certain example embodiments, the communication channel provides structured communications to provide inputs to the LLMs, using a context-based protocol.

In certain example embodiments, the context-based protocol incorporates contextual data into the structured communications.

In certain example embodiments, the contextual data includes tool calls.

In certain example embodiments, the context-based protocol is Model Context Protocol (MCP).

In certain example embodiments, the first AI agent is running on a local computer system, the data input mechanism being provided to the local computer system by a remote server.

In certain example embodiments, the first AI agent is running on a remote server and the second AI agent is running on a local computer system, the communication channel connecting the remote server and the local computer system via a communications network.

In certain example embodiments, the first AI agent and the second AI agent are provided by an agent provider operable between a remote server and a local computer system providing a user interface in communication with the second AI agent.

In certain example embodiments, the data input mechanism includes a web page.

In certain example embodiments, the web page is inspected to determine the interaction elements using document object model (DOM) introspection.

In certain example embodiments, the data input mechanism is inspected via an application programming interface (API) utilized by the first AI agent.

In certain example embodiments, the method further includes determining a change in the web page from an input provided to an interaction element; updating the input schema; and providing the updated input schema to the second AI agent via the communication channel.

In certain example embodiments, the method further includes receiving, by the first AI agent, via the communication channel, at least one input to be entered into the interaction elements based on the updated input schema; and entering, by the first AI agent, the at least one input.

In certain example embodiments, entering an input to one of the interaction elements causes a dynamic change to the web page.

In certain example embodiments, the change in the web page is caused by progressing from a first webform to a second webform used in completing the interactive process.

In certain example embodiments, at least one input is obtained by processing a token.

In certain example embodiments, the method further includes using the token to obtain the at least one input from a third party.

In certain example embodiments, the data input mechanism includes a web page and the action comprises submitting a completed webform.

In another aspect, there is provided a computer system comprising: a processor; and a memory, the memory storing processor executable instructions that, when executed by the processor, cause the computer system to receive, at a first computer-implemented AI agent via a communication channel, a request to complete an interactive process with a structured or semi-structured data input mechanism; inspect, by the first AI agent using an LLM, the data input mechanism for interaction elements usable in the interactive process to provide input; generate, by the first AI agent using the LLM, based on the interaction elements, an input schema for one or more tools invokable by the first AI agent that are capable of determining inputs to provide using the interaction elements; and provide, by the first AI agent, the input schema via the communication channel, to have the one or more tools invoked to have the interaction elements completed.

In another aspect, there is provided a computer-readable medium storing processor executable instructions that, when executed by a processor of a computer system, cause the computer system to receive, at a first computer-implemented AI agent via a communication channel, a request to complete an interactive process with a structured or semi-structured data input mechanism; inspect, by the first AI agent using an LLM, the data input mechanism for interaction elements usable in the interactive process to provide input; generate, by the first AI agent using the LLM, based on the interaction elements, an input schema for one or more tools invokable by the first AI agent that are capable of determining inputs to provide using the interaction elements; and provide, by the first AI agent, the input schema via the communication channel, to have the one or more tools invoked to have the interaction elements completed.

### Dynamic Negotiation and Execution of Data Input Mechanisms

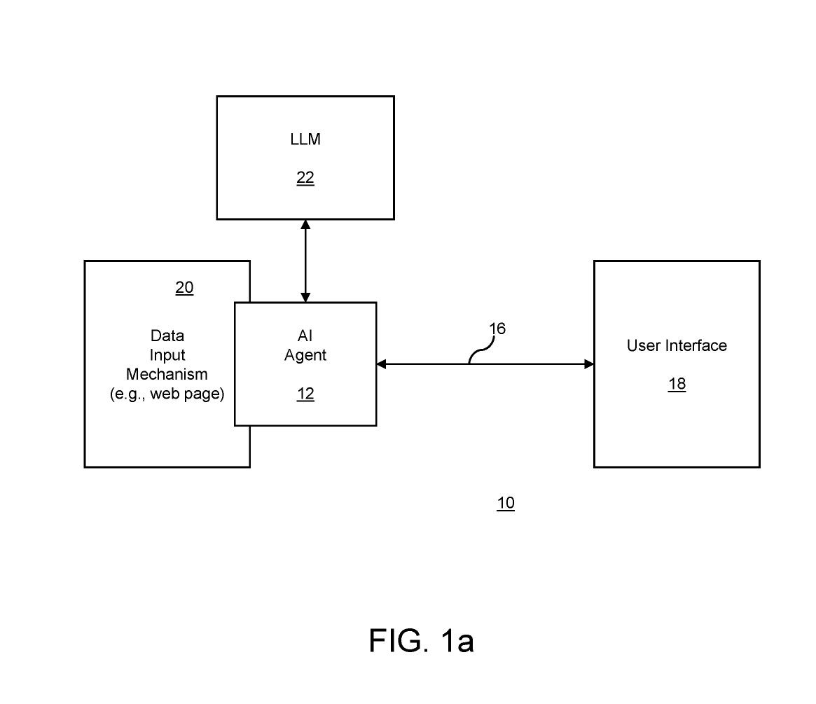

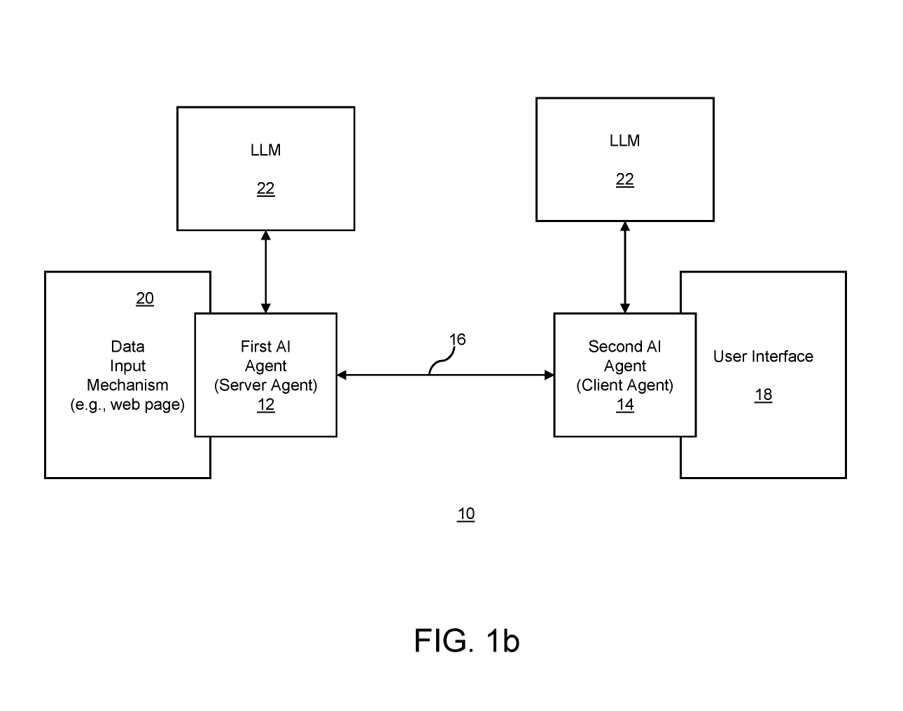

Referring now to the figures, FIGS. 1a and 1b illustrate an example of a computing environment 10 in which one or more AI agents 12, 14 may be utilized via a user interface 18 to interact with a structured or semi-structured data input mechanism 20 (referred to herein as the “data input mechanism”) such as a web page. The AI agent(s) 12, 14 may include or have access to a large language model (LLM) 22. That is, the AI agent(s) 12, 14 may provide an interactive interface for utilizing the LLM 22 in performing operations and executing interactive processes as described herein.

Referring first to FIG. 1a, the AI agent 12 is in communication with or otherwise capable of interacting with the data mechanism 20 to dynamically execute operations in an interactive process. The AI agent 12 includes or has access to the LLM 22 and thus may be embodied as an AI-powered chatbot or other AI-powered entity (e.g. Perplexity™, ChatGPT™, etc.) that may accept inputs, prompt the LLM 22 to generate a response, and utilize the response in performing a step, task, instruction, or operation or to generate content to be used in a step, task, instruction or operation. The AI agent 12 may receive data and information from a user interface 18 via a communication channel 16. The communication channel 16 may include a communication network and utilize a particular protocol as herein described.

Such communication network(s) may include a telephone network, cellular, and/or data communication network to connect different types of client- and/or server-type devices. For example, the communication network may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The AI agent 12, data input mechanism 20, LLM 22, and user interface 18 may be provided by or with one or more computing devices as discussed further below. Such computing devices (or computing systems) may include, but are not limited to, a mobile phone, a personal computer, a laptop computer, a server computer, a tablet computer, a notebook computer, a hand-held computer, a personal digital assistant, a portable navigation device, a wearable device, a gaming device, an embedded device, a virtual reality device, an augmented reality device, etc.

With respect to the LLM 22 (and/or LLM-powered chatbot), examples of generative models that may be used include, for example, OpenAI’s Generative Pre-trained Transformer family (GPT 3.5, GPT 4, ChatGPT), Meta’s Llama and Llama 2, CohereAI’s Command, Mistral/Mixtral, Anthropic’s Claude, Google’s Gemini, Gemma and Bard. These general purpose and chat-focused models may be used by the AI agent 12, e.g., by accessing the LLM 22. It can be appreciated that, in addition, more specialized models may be used. For example, the Code Llama, HuggingFace’s CodeGen, Github Copilot’s Codex model or similar may be used. In some cases, instead of text generation models, multimodal or multimedia models may be used such as BLIP-2, CLIP, or GPT-4V. These may be used to analyze user interfaces or user interface elements, or generate user interfaces or user interface elements. The LLM 22 and/or AI agent 12 may, additionally or alternatively, use a fine-tuned model, e.g., by fine tuning a Llama model or other baseline model.

It can be appreciated that although transformer-based language models are described herein, the present disclosure may be applicable to any ML-based language model, including language models based on other neural network architectures such as RNN-based language models. Indeed, the consideration of an LLM 22 and/or AI agent 12 above are by way of example and the present disclosure and principles are not necessarily so limited. For example, the techniques described above may be applied to other generative models such as, for example, other text generation models or multimedia models such as may serve to generate other forms of output or accept other forms of input beyond text (and which may, in some implementations, potentially include a generative text model along with one or more other models). In a specific example, a generative model (e.g., a multimedia model) that includes, amongst other types of models, an LLM 22 in it, may be employed in association with the techniques discussed in the present disclosure.

Referring now to FIG. 1b, in some implementations, the AI agent 12 may be considered a “first” AI agent 12 or a “server” AI agent 12 that is connected to a “second” or “client” AI agent 14 via the communication channel 16. Each of the first and second AI agents 12, 14 may include or have access to an LLM 22, which may be the same LLM 22 or different LLMs 22. In the configuration shown in FIG. 1b, the second AI agent 14 acts as a client agent to receive inputs and instructions via or with the user interface 18. It can be appreciated that the use of separate server and client agents 12, 14 may be advantageous in separating functionality between local and remote systems as well as within various client-server relationships. However, as illustrated in FIG. 1a, a single AI agent 12 may be used to perform the operations and apply the principles discussed herein. It can be appreciated that the communication channel 16 may utilize a particular communication protocol via a communication network or represent any other suitable communication connection or software interface or data transfer bus, whether within a single computing entity or between multiple different computing entities.

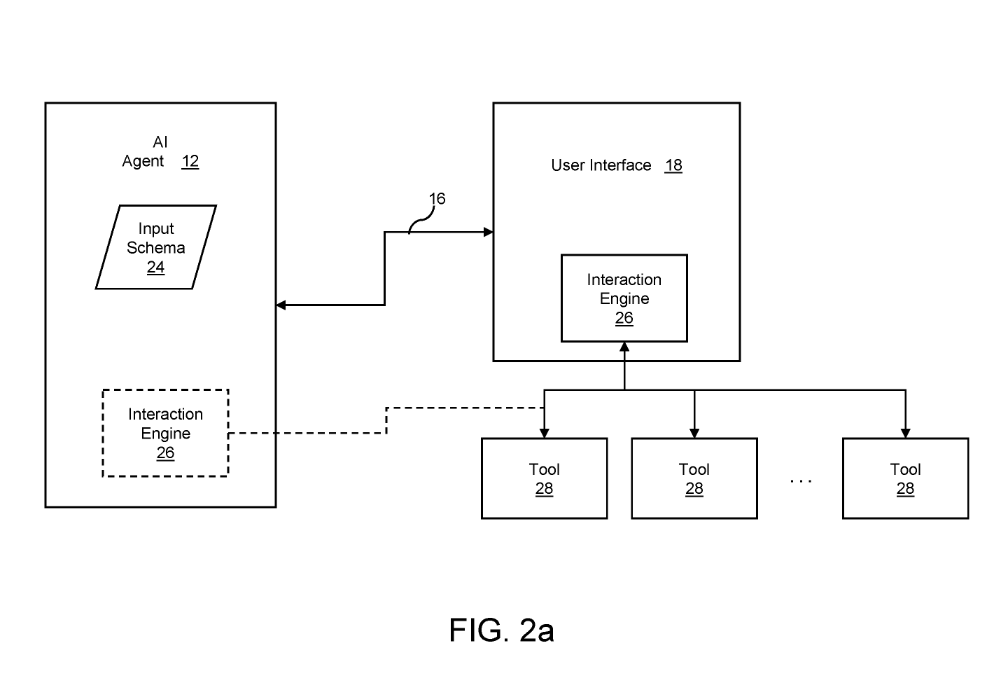

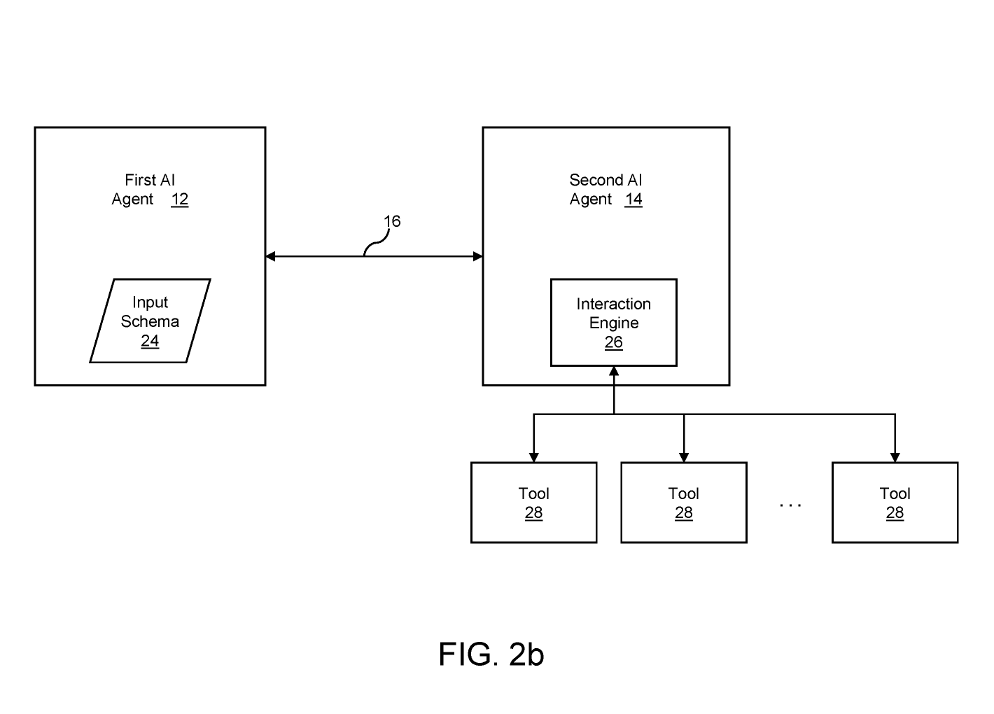

FIG. 2a illustrates an example of a configuration for implementing the computing environment 10 shown in FIG. 1a. The AI agent 12 in this example may generate and update an input schema 24 associated with a data input mechanism 20 that has been examined (e.g., via introspection). The AI agent 12 may interact with the user interface 12 via the communication channel 16 to provide the input schema 24 to an interaction engine 26. The interaction engine 26 may be configured to communicate with, invoke, make requests to, and receive responses from, various tools 28. The tools 28 may be part of a fixed set of tools 28 that may be adapted according to the input schema 24 and/or may be a dynamically changing set of tools 28 that is accessed, created, grouped or otherwise obtained to adapt to a particular input schema 24. As shown by way of dashed lines in FIG. 2a, the AI agent 12 may, additionally or alternatively, host the interaction engine 26 and invoke the tools 28 directly, rather than via the user interface 18.

FIG. 2b illustrates an example of a configuration for implementing the computing environment shown in FIG. 1b. In this configuration, the second AI agent 14 may include or otherwise have access to the interaction engine 26 to communicate with and invoke the tools 28 as discussed above. In this way, the second (client) AI agent 14 may communicate with the first (server) AI agent 12 to examine the data input mechanism 20 to generate or update the input schema 24 to have the second AI agent 14 invoke the corresponding tools 28 and/or configure a fixed set of tools 28 in a desired way. In some implementations, the tools 28 may be co-located on the same server or in some way coupled with the first AI agent 12. In some implementations, the tools 28 may directly manipulate the data input mechanism 20.

The AI agent(s) 12, 14 may utilize a standardized messaging protocol where the interface provided by the data input mechanism 20 acts as a "server" exposing capabilities, while the AI agent 12 acts as a "client" discovering and utilizing these capabilities. The protocol may be implementation-agnostic and work both for embedded interfaces (e.g., iframe, webview, etc.) and remote servers, providing consistency across implementations.

An example implementation may utilize JSON-RPC with the Model Context Protocol (MCP) running across it. This enables bidirectional transmission of the types of information described herein. In this example, an MCP Server may be coupled to the data input mechanism 20 (e.g., a checkout or other type of web form). The MCP Client may be provided as the user’s AI agent 12, 14 or a browser client or other local or remote system. While the MCP protocol is described here and shown in the figures below, another agent-to-agent communication protocol or message format could also be used.

The AI agent 12 (FIG. 1a) or second AI agent 14 (FIG. 1b) may discover the available checkout actions by requesting a tool 28 or tools 28 with data based on a current input schema 24 determined from the data input mechanism 20 (e.g., checkout interface). Each tool 28 may include a name, description, and input schema 24 defining required parameters. The interface providing the data input mechanism 20 (e.g., checkout process) may dynamically generate the input schemas 24 for this list based on its current state, configured business logic, and customizations defined at the server being used (e.g. settings a merchant chooses for an e-commerce website). In this way, the system described herein may adapt and support an endless number of different configurations and implementations for the data input mechanism 20. For example, the system may adapt to any unique checkout interface by allowing the checkout interface (e.g., server AI agent 12) to examine (e.g., introspect) the experience that would be shown to the user and reflect the required tools 28 and actions to the user interface 18 or second AI agent 14 where appropriate.

In an implementation, a fixed number of core tools 28 (e.g., three tools - create_checkout, update_checkout, submit_checkout), which may or may not be limited, may be provided. The dynamism in the system may be provided by providing dynamically changing input schema 24 for these tools 28. For example, the update_checkout tool may require dynamic changes to the input schema 24 for that tool 28 to adapt to changing web forms. This input schema 24 may change based on the state of the form and may include various input fields or options in the form (e.g., checkout form). The “update” tools 28 may accept a very large input schema 24, covering many potential fields, allowing for a single action update to many fields at once, if the corresponding information is known.

In an example, a basic checkout may expose tools 28 such as set_name, set_address, set_payment_token, and submit. When a merchant enables additional business logic, such as support for local pickup, multiple shipping options, an additional input for an input schema 24 for one of these tools 28 may be exposed as part of initial negotiation or in response to input that has been provided. Each listed tool 28 may include a structured schema describing required inputs, which may be dynamically changing as noted above, allowing the second (client) AI agent 14 to understand parameter requirements. In another implementation, a dynamic list of tools 28 may be used, which have a 1:1 relationship with the form fields or DOM elements in a webpage (or not). In such an implementation, the tool generation process may combine several fields into a single tool 28, for example a House Number field, Street Field, City Field, and State field may be grouped into a single “Street Address” tool 28.

Another aspect may include the dynamic updating of input schemas 24 for the available tools 28 based on the state of the data input mechanism 20 (e.g., state of a checkout process). For example, when checkout requirements change (e.g., when selecting a specific country requires additional information), the checkout interface may update its input schema 24 for the available tools 28 to include new required parameters, and send a notification to the second (client) AI agent 14 indicating the input schema 24 for the tool(s) 28 has/have changed. The AI agent 14 may receive this notification and refresh its understanding of available inputs for the tool(s) 28. In other cases, the when the tool 28 is called, the system may modify the state of the webpage or other dynamic input mechanism 20, which causes the data input mechanism 20 to change.

This dynamic communication flow allows the interactive process workflow (e.g., checkout) and AI agent(s) 12, 14 to react and adapt to complex interactive workflows present in many data input mechanisms 20, such as, for example, checkout experiences. This may reduce or even eliminate the need for human intervention present in other systems. The updated input schema 24 and its dynamic update may be sent either in response to an input or change from the client side, or it may be sent asynchronously (for example triggered by a state change on the server side).

One method to drive an interactive process submission (e.g., checkout or any form submission) programmatically may be to inspect a dynamic webpage via introspection. This may include introspecting the DOM of a webpage and reflect an input schema 24 and/or a set of tools 28 from the forms and fields exposed in the DOM.

In another example, for specific platforms, the “server” component may use direct software interfaces such as APIs to understand a form structure and state. Additionally, if required, browser orchestration may be used to handle client-side UI extensions (e.g., for pickup points) that APIs do not expose. The protocol used may itself abstract these underlying implementation details from the client AI agent 14. Moreover, while various backend methods may be used (e.g., introspection, APIs and/or browser orchestration, etc.), the protocol (e.g., MCP) may provide a consistent interface to the client agent regardless of the backend method utilized by the server.

In an example, the sources of information the server agent can use to construct an input schema 24 for a list of tools 28 (or a dynamically assembled list of tools 28) may include but is not limited to the HTML, CSS, JavaScript, JSON files used to render the page. This may involve fully rendering the page with a typical rendering engine or parsing one or more files to match text indicative of a feature of the web page that corresponds to a tool 28 that can be exposed to the client AI agent 14.

For instance, the page may be rendered by a rendering engine (not shown) and the DOM constructed from there. The DOM is a tree structure representing the webpage in a computer memory. The tree is traversed, and forms and form fields may be extracted. An input schema 24 for the set of tools 28 (or a dynamically assembled list of tools 28) is generated by this process of “walking the DOM”, and this input schema 24 and/or list of tools 28 provided by the “server” to the “client”. In one example, the system may find all form elements such as in text input fields and other input fields and list each one as an input in an input schema 24 for a tool 28 or a tool 28 for that input field. In another example, two or more input fields may be grouped into the input schema 24 or grouped into a single dynamically generated tool 28. The field name, field type, field value or default value, field size, and other attributes of the field read from the rendered DOM or from the source files directly may be used in the input schema 24 element’s name or description that is transmitted to the client AI agent 14.

The performance of the AI agents 12, 14 may be enhanced by providing additional context alongside the name in the input schema 24. This context may be tokenized and fed as input to the context window of the client providing additional information to the LLM 22. The LLM 22 may be leveraged to map the user’s known facts/intents to the dynamically changing input schema 24 provided by the server side. The LLM 22 may translate “amorphous” input schema 24 from the server side using known facts about the user (e.g., buyer), to call the associated tool 28 in the correct format, e.g., to provide a structured input required by the tool’s schema.

One source of additional information to construct the input schema 24 for the set of tools 28 may be semantic or descriptive information found in webforms that follow the accessible rich internet applications (ARIA) guidelines. The web accessibility initiate (WAI)-ARIA standards and guidelines provide a mechanism to include semantic information about widgets, structures, and behaviors, in order to allow assistive technologies to convey appropriate information (see, for example: https://www.w3.org/TR/wai-aria/). This semantic information may be used by a model at the server side to generate the input schema 24 and associated descriptions that are transmitted to the client side. The semantic information may be transmitted by the server side to the client side within the input schema 24 where the client side inputs the semantic information into a model.

Additionally, as some fields in a form are required and others are optional, the input schema 24 for the tools 28 generated and transmitted to the client side may include information about which tools 28 are required or not required. This input schema 24 may update dynamically as the state of the dynamic input mechanism 20 (e.g., webpage) changes, in response to tools 28 used or other events. In some cases, the order in which the tools 28 are used may be less relevant, while in other cases there may be a recommended or required order to use the tools 28. Information about the order, precedence, or priority level of the set of available tools 28 for implementing the input schema 24 may be included in the data communicated from the server side to the client side (e.g., via the communication channel 16). Semantic information about the tools 28, semantic information representing the tools 28 required to proceed to the next step or process, and semantic information about the overall requirements to complete the form may be included.

The system may be configured to provide structured error handling, allowing the checkout to indicate when additional information is required or when validation errors occur. This may be done to enable the AI agent(s) 12, 14 to iteratively refine inputs (e.g., in a checkout or other submission process), until all requirements are met, or surface a portion of the user interface 18 to the user to take over and complete operations/transactions manually.

As indicated above, an explicit interaction loop may be implemented where an agent 12, 14 calls a tool 28 (e.g., update_checkout) with data based on a current input schema 24. The server side (e.g., MCP server) may process the date, update the form state and then respond to the second AI agent 14. The response may include the result (e.g., current cart/checkout state), any errors or warnings (e.g., “field missing”, “validation failed”, etc.), and the updated input schema 24. The updated input schema 24 may reflect any new/changed fields due to the last action. The AI agent 14 may use this updated input schema 24 for the next iteration, continuing this loop until no errors/warnings or a completion state is reached.

One method to determine a validation error involves the server side AI agent 12 (e.g., “checkout” agent) receiving the input schema 24 or other tool-related input from the client AI agent 14, the input schema 24 or tool-related input containing text corresponding to one or more fields of the data input mechanism 20 (e.g., checkout form) that may be used to determine the input schema 24 and/or tools 28 required.

The server AI agent 12 may provide a text input to the form fields in the DOM and receive a response from the form validation logic. The form validation may be performed on the client side or on the server side. In this context, the client side of the web application corresponds to server-side of the AI agent 12 running the DOM and any JavaScript in the context of the page. Server-side form validation may involve submitting the form and receiving a response from a web server. In either case, the form input may lead to an input validation error. The error may be received by the server which, based on the error text, updates the input schema 24 for the set of tools 28. The updated input schema 24 may be subsequently transmitted to the client side. The updated input schema 24 may include the current state of the field (e.g. including the invalid input) along with the error message or statement from validation.

In cases where direct user interaction is requested or required (e.g., for complex legal or business requirements), the system may support switching to a "foreground" mode where the data input mechanism 20 (e.g., checkout interface) may request direct user interaction for specific portions of the process while maintaining the overall state.

The determination to leave the automated mode and send a request to enter a user-interactive mode may be made at the server side in response to input schema 24 or an input indicative of the input schema 24 received from the client AI agent 14 over the communication channel 16. The determination to leave the automated mode and enter a user-interactive mode may be made at the client side in response to the input schema 24 for the set of tools 28, received from the server AI agent 12 over the communication channel 16.

Communication from the server side to the client side to indicate or request transition to a foreground or interactive mode may be sent over the same communication channel 16 as the input schema 24 for the set of tools 28, or a different interface.

Once the system has received input from the client AI agent 14 in the form of input schema 24 for the tools 28 being used, the system may update the state of the dynamic data input mechanism 20 (e.g., dynamic web page). A determination may be made when the form (e.g. checkout form) is completed by checking that all required fields have been satisfied. An indication of the completion of the form may be communicated from the server side to the client side over the same communication interface as the tool list, or via a different interface. In one example, completion of the interactive process may include submission of a payment. In such an example, an input may be obtained by processing a token. In general, the token may be any identifier or pointer as a substitute for the actual value associated with an input. For example, the token may be obtained from a payment processing service or may be stored locally. The token may be used by the first AI agent 12 to obtain the input from a third party, which in this example may be payment details. In can be appreciated that utilizing tokens to obtain inputs from third parties (i.e., others separate or remote from the AI agents 12, 14) may apply to any tokenized data that is utilized as an input to an interactive process. In another example, the token may be used to anonymize personally identifiable information (PII) or any other potentially sensitive information.

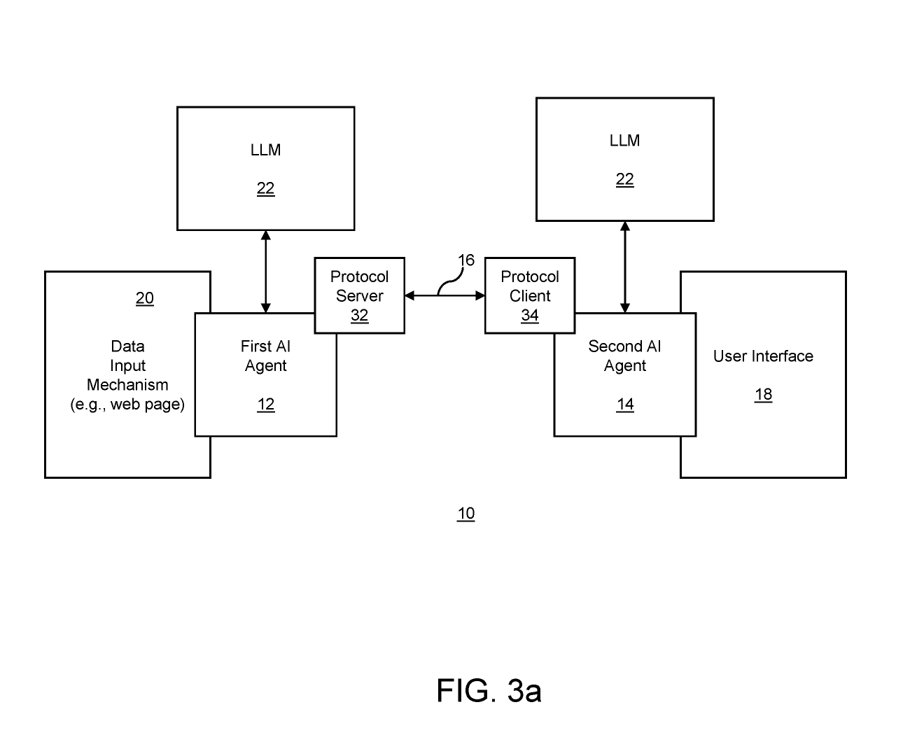

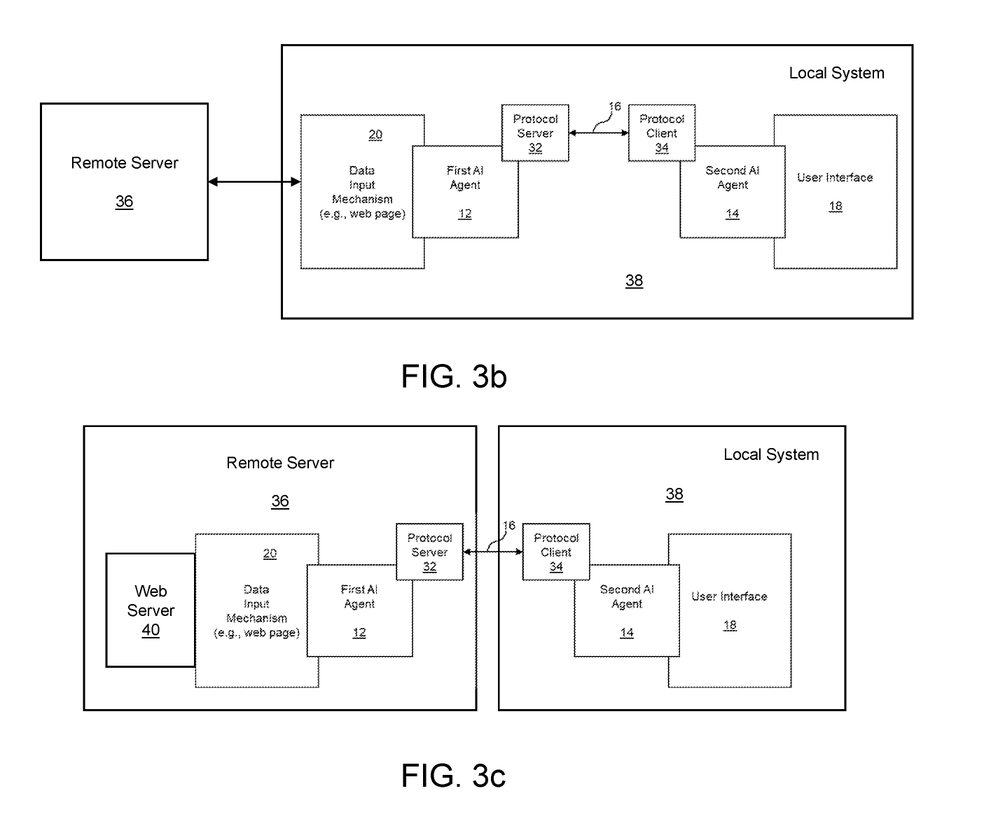

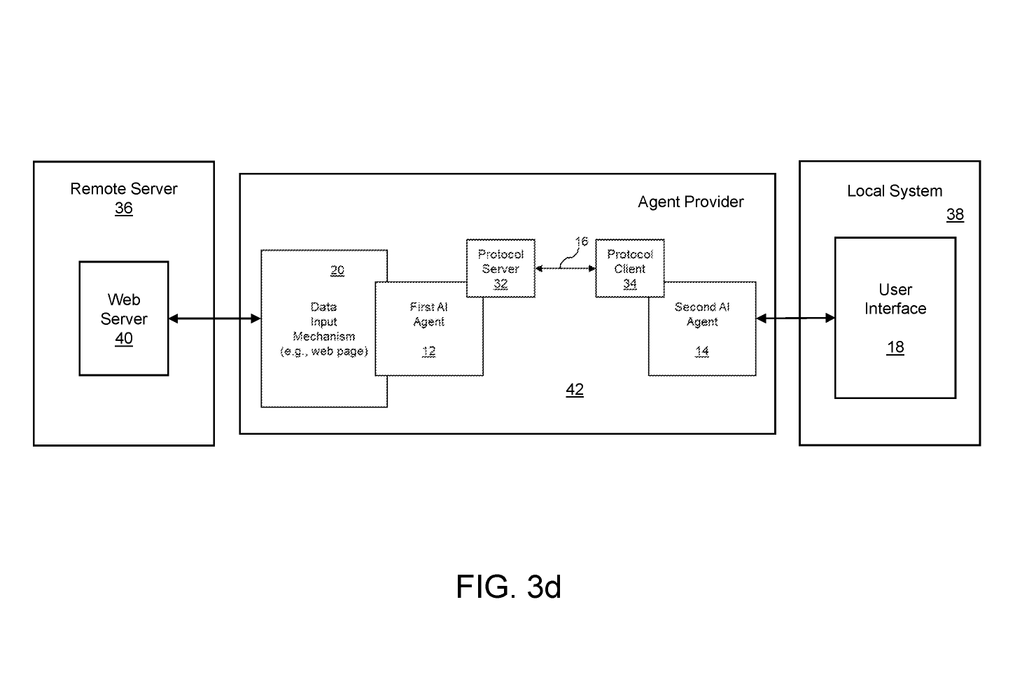

Referring now to FIGS. 3a-3d various example configurations for implementing the computing environments 10 shown in FIGS. 1a and 1b (and further illustrated in FIGS. 2a and 2b) are provided. It can be appreciated that while the examples shown in FIGS. 3a-3d utilize first and second AI agents 12, 14, the architectures may be adapted to utilize a single AI agent 12 (e.g., as shown in FIGS. 1a and 2a).

Referring to FIG. 3a, the first AI agent 12 includes or is in communication with a protocol server 32, which communicates with a protocol client 34 via the communication channel 16. The protocol client 34 is included with or otherwise in communication with the second AI agent 14 at the client side. In this configuration, the first AI agent 12 interfaces with the data input mechanism 20 (e.g., web page) and has access to the LLM 22 as discussed above. The first AI agent 12 may communicate with the second AI agent 14 via a communication protocol utilized by the protocol server 32 and protocol client 34. The second AI agent 14 may be included or otherwise interfaced with the user interface 18, e.g., to initiate interactive processes via an application utilized by a user. The second AI agent 14 may include or have access to the LLM 22 as discussed above.

The configuration shown in FIG. 3a may be deployed in various client-server configurations. For example, as shown in FIG. 3b, an architecture is shown where the web server is remote and provided on a remote server 36, and the first and second AI agents 12, 14 are running locally in a local system 38. The first AI agent 12 may be coupled to the rendered web page or DOM. In this configuration, it may be able to transmit and receive data over an interface with the second AI agent 14. The second AI agent 14 operates on the user’s instructions to perform a task. This may be implemented in a browser with the browser’s rendering engine providing DOM access to a browser plugin that performs the functions. It could also be implemented in a desktop or mobile application that leverages a webpage/DOM rendering engine and uses LLMs 22 operating locally on the desktop or mobile device.

In another example of a client-side architecture, an AI agent 14 may be configured to run within a user's application (e.g., a mobile app using an SDK). This AI agent 14 would interact with a hidden/off-canvas web view rendering the data input mechanism 20 (e.g., checkout page). The same protocol (e.g., MCP with fixed tools 28 and dynamic input schemas 24) may be used between the in-app AI agent 14 and the local web view. This may be considered an enhanced, "autofill++" running locally within or between apps. That is, an AI agent 14 (e.g., in a mobile app) may orchestrate a local, possibly hidden, web view rendering a form, using the same standardized communication protocol.

FIG. 3c depicts an architecture in which the first AI agent 12 interfaces with the data input mechanism at the web server 40 on a remote server 36. The first AI agent 14 may communicate remotely with the second AI agent 14 running on the local system 38.

Referring now to FIG. 3d, an architecture is illustrated where the first and second AI agents 12, 14 are provided via a third party service such as an agent provider 42. In this example, the first AI agent 12 may remotely retrieve a web page from the remote server 36 and process that web page to determine a set of available tools 28. The set of tools 28 may be communicated over an interface to the second AI agent 14 that operates based on an interface with the user and based on the user’s intent, where applicable, by interfacing with the user interface 18 on a local system 38. The user intent may be provided remotely from another system (referred to as the agent provider 42 in FIG. 3d), via a user interface, API or another transport/connection.

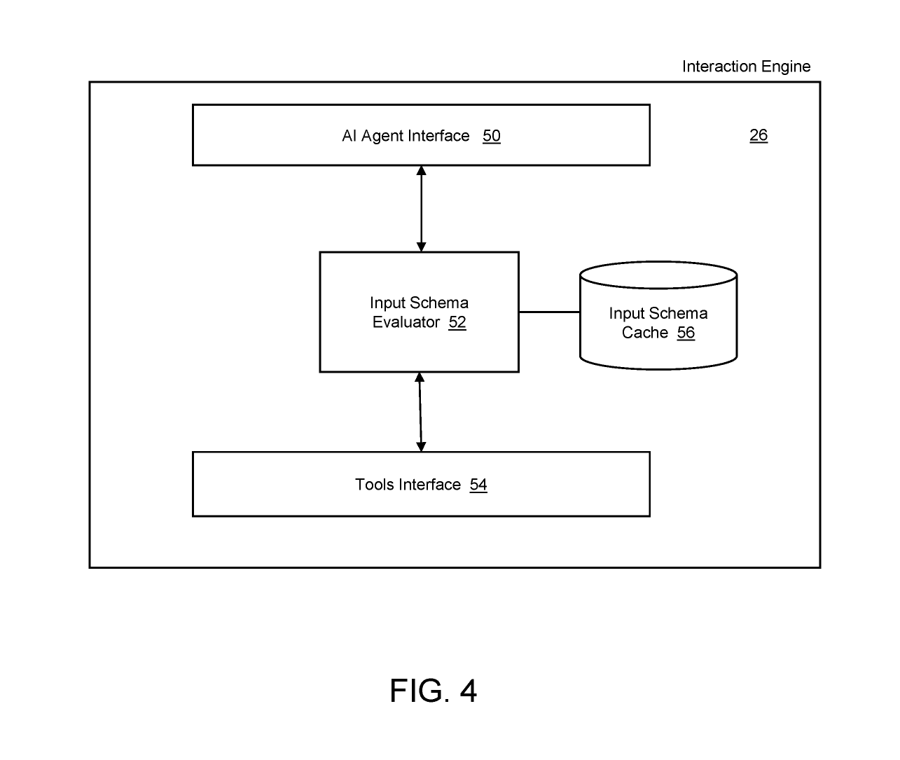

A configuration for the interaction engine 26 is shown in FIG. 4. The interaction engine 26 may include one or more AI agent interfaces 50 to allow the AI agents 12, 14 to access and utilize the interaction engine 26 to invoke the tools via one or more tools interfaces 54. The interaction engine 26 may include an input schema evaluator 52 to allow the interaction engine 26 to determine which tools 28 to invoke and for what purpose, which may include interpreting a specific communication protocol such as MCP as provided by way of example above. The input schema evaluator 26 may include an input schema cache 56 to store current input schemas 24 used in evaluating which tools 28 to invoke.

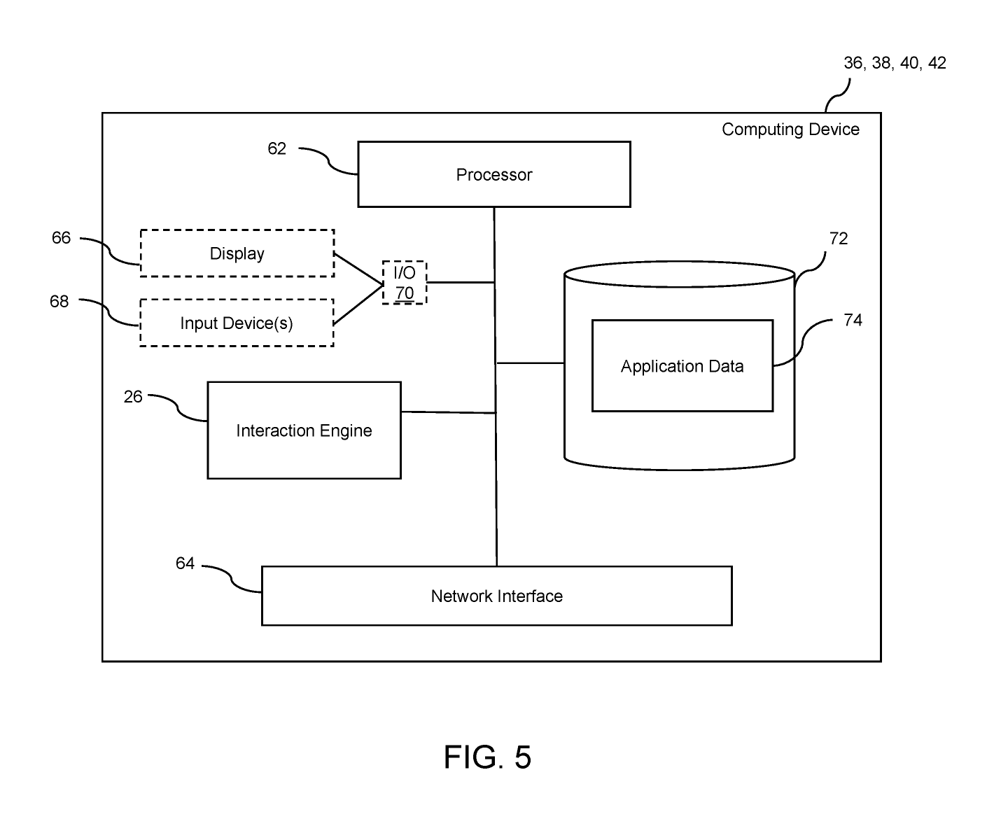

FIG. 5 shows an example of a computing device (e.g., a remote server 36, local system 38, web server 40, agent provider 42, etc.) which may be utilized by any one or more of the entities shown in FIGS. 1-4, for example, a personal electronic device or server used to create one of the architectures shown in FIGS. 3a-3d. The computing device 36, 38, 40, 42 in FIG. 5 may, additionally or alternatively, provide an example of a computing entity or system on which the LLM 22 may be deployed or accessed.

In this example, the computing device 36, 38, 40, 42 includes one or more processors 62 (e.g., a microprocessor, microcontroller, embedded processor, digital signal processor (DSP), central processing unit (CPU), media processor, graphics processing unit (GPU) or other hardware-based processing units) and one or more network interfaces 64 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device 36, 38, 40, 42 may additionally include the interaction engine 26, a data store 72, and application data 74. The interaction engine 26 may therefore be provided on either or both the client side or the server side and is shown in FIG. 5 for illustrative purposes. Although not shown in FIG. 5, when configured as a client device (e.g., local system 38), the computing device or computing system may additionally include a client application and/or user interface 18. The computing device 36, 38, 40, 42 may, additionally, include or otherwise have access to databases according to data and information that it accesses and utilizes according to examples provided herein.

The data store 72 may represent a database or library or other computer-readable medium configured to store data and permit retrieval of data by the computing device 36, 38, 40, 42. The data store 72 may be read-only or may permit modifications to the data. The data store 72 may also store both read-only and write accessible data in the same memory allocation. In this example, the data store 72 stores the application data 74 for an application and/or data for a client application, a server application, and/or the interaction engine 26 that is configured to be executed by the computing device 36, 38, 40, 42 for a particular role or purpose.

While not delineated in FIG. 5, the computing device 36, 38, 40, 42 includes at least one memory or memory device that can include a tangible and non-transitory computer-readable medium having stored therein computer programs, sets of instructions, code, or data to be executed by processor(s) 62. The processor(s) 62 and network interface(s) 64 are connected to each other via a data bus or other communication backbone to enable components of the computing device 36, 38, 40, 42 to operate together as described herein. FIG. 5 illustrates examples of modules and applications stored in memory on the computing device 36, 38, 40, 42 and executed by the processor(s) 62.

It can be appreciated that any of the modules and applications shown in FIG. 5 may be hosted externally and may be available to the computing device 36, 38, 40, 42, e.g., via the network interface 64. The data store 72 in this example stores, among other things, the application data 74 that can be accessed and utilized by an application. The data store 72 may additionally store one or more software functions or routines in a cache or in other types of memory.

As shown in FIG. 5, the computing device 36, 38, 40, 42 may, optionally (e.g., when configured as a personal electronic device such as a smartphone or tablet), include a display 66 and one or more input device(s) 68 that may be utilized via an input/output (I/O) module 70. That is, such components may be omitted when the computing device 36, 38, 40, 42 does not interact with a user.

While examples referred to herein may refer to a single display 66 for ease of illustration, the principles discussed herein may also be applied to multiple displays 66, e.g., to view portions of UIs rendered by or with an application on separate side-by-side screens. That is, any reference to a display 66 may include any one or more displays 66 or screens providing similar visual functions. UI(s) may receive one or more inputs from one or more input devices 68, which may include or incorporate inputs made via the display 66 as well as any other available input to the computing environment 10 (e.g., via the I/O module 70), such as haptic or touch gestures, voice commands, eye tracking, biometrics, keyboard or button presses, etc. Such inputs may be applied by a user interacting with the computing environment 10, e.g., by operating the client device 36, 38, 40, 42.

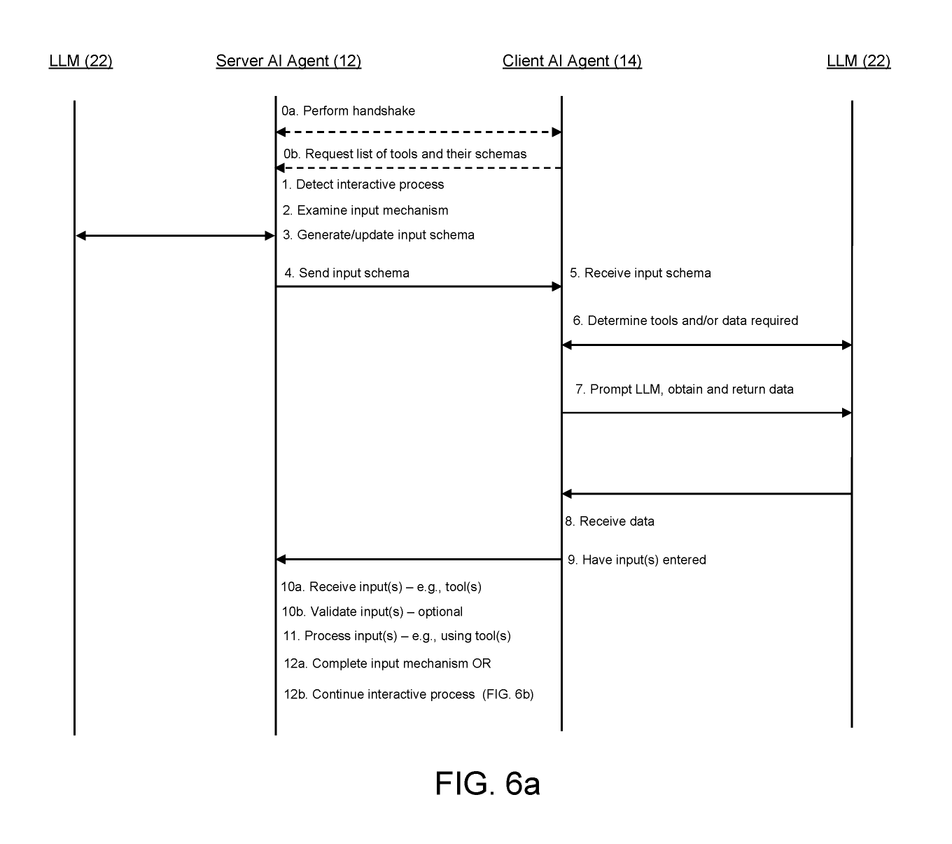

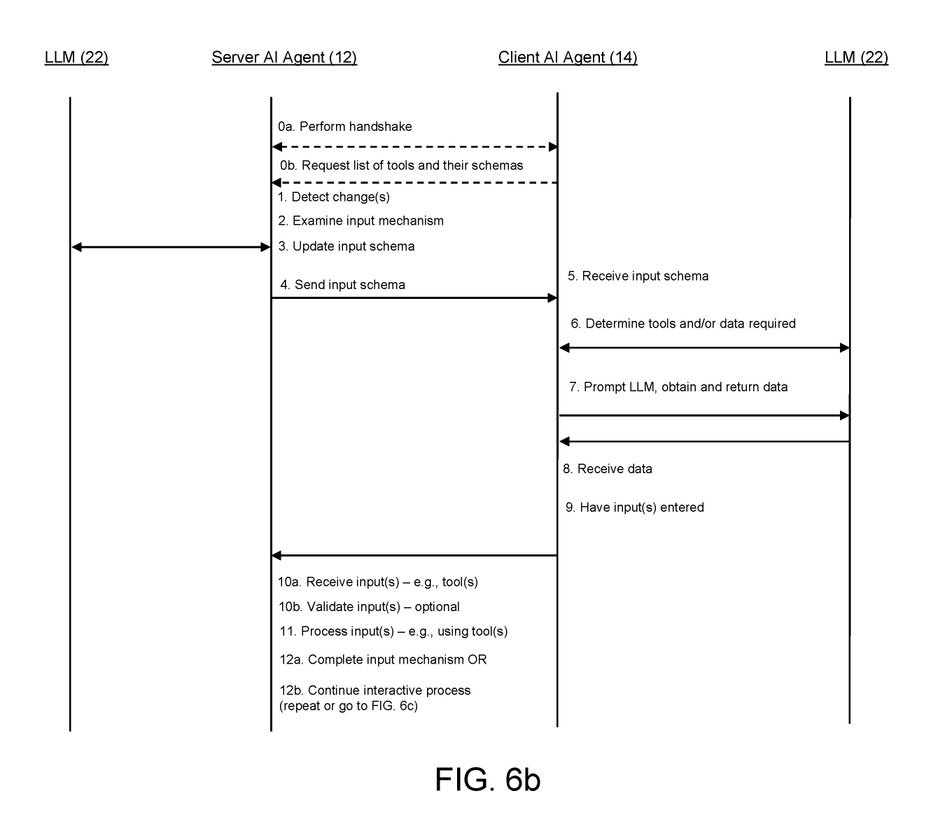

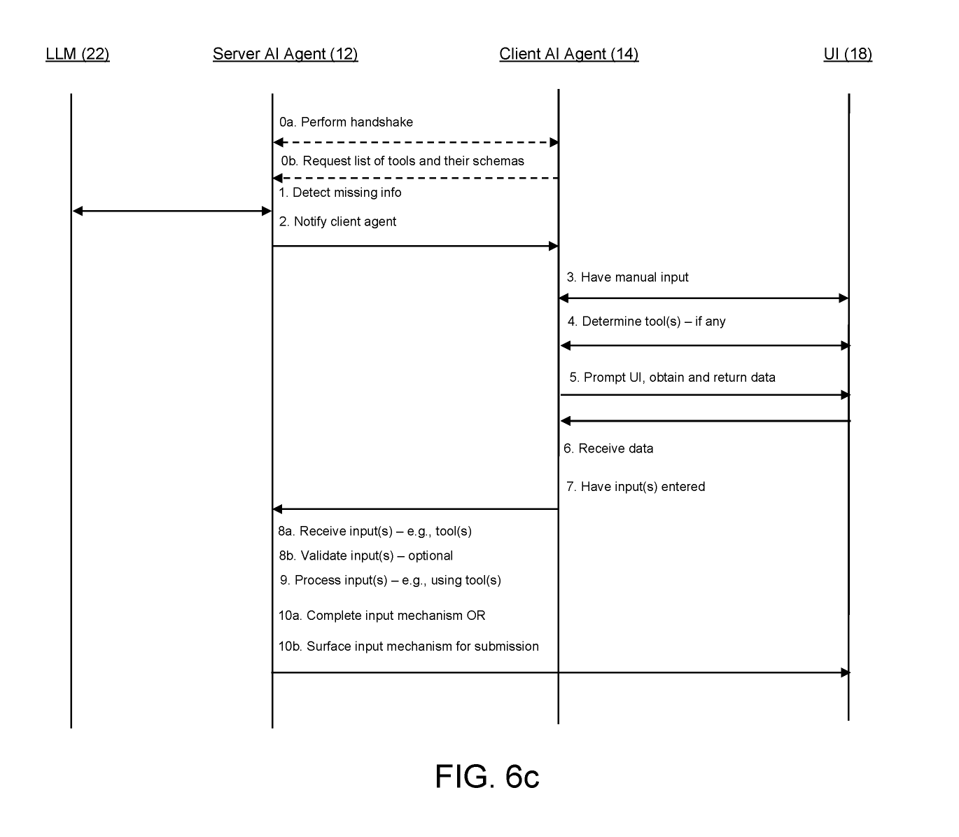

Referring now to FIGS. 6a-6c, sequence diagrams are shown illustrating example operations that may be executed in negotiating and executing interactive processes with data input mechanisms 20.

Referring first to FIG. 6a, optionally at step 0a, the client AI agent 14 and the server AI agent 12 may perform a handshake. Optionally, at step 0b, the client AI agent 14 may request a list of the tools 28 and their schemas. At step 1, the server AI agent 12 detects that the interactive process has been initiated, which may be detected based on an interaction with the data input mechanism 20 (e.g., by the client AI agent 14, user interface 18, etc.) or based on a message or communication received from, for example, the client AI agent 14. At step 2, the server AI agent 12 examines the data input mechanism 20, e.g., via DOM introspection, Accessibility Tree introspections, via an API or other software interface, as discussed above.

At step 3, the server AI agent 12 generates a new input schema 24 or updates an existing input schema 24 (e.g., when a default or baseline schema 24 is adapted for different data input mechanisms 20). As illustrated in FIG. 6a, the server AI agent 12 may utilize the LLM 22 to interpret data determined at step 2 in order to adapt the input schema 24 to the current state of the data input mechanism 20.

At step 4, the server AI agent 12 sends the input schema 24 to the client AI agent 14. The client AI agent 14 receives the input schema 24 at step 5 and, at step 6, determines, from the input schema 24, the tools 28 and/or data required at step 7. At step 7, the client AI agent 14 may prompt the LLM 22 to perform operations, obtain data, and return the obtained data.

Data is returned to the client AI agent 14 who receives the data obtained by the LLM 22 at step 8 and has one or more inputs entered at step 9.

In the configuration shown in FIG. 6a, the client AI agent 14 communicates with the server AI agent 12 via the communication channel 16 such that the server AI agent 12 receives the input(s) at step 10a, which may include the tools 28, optionally validates the input(s) at step 10b, and processes the input(s) at step 11, e.g., using the tools 28. That is, the client AI agent 14 may examine the tools 28 and input schema 24 received from the server AI agent 12 and performs operations to generate or retrieve data to fill out the required fields in that schema 24. This may be done to complete the goals or actions the client LLM 22 has been instructed to perform. The tools 28 and input schema 24 may thus be used as a structured language of what data is needed/requested/required that is sent between the server AI agent 12 and the client AI agent 14, instead of a separate server. The server AI agent 12 may or may not invoke another server, local code, etc., in response to receiving the tool input/data/command. The input/data/command may be used to update state, then optionally, based on the updated state, may iterate again with a new tool/schema, or complete (the action, e.g., checkout) as shown in FIGS. 6b and 6c as additional examples. As indicated above, the inputs may trigger dynamic changes to the data input mechanism 20, e.g., for multi-stage webforms and the like, or may be entered using a single operation.

Steps 12a and 12b illustrate alternative paths. At step 12a, inputs to the data input mechanism 20 may be completed based on the tool operations at step 11 and the data input mechanism 20 may be completed, e.g., webform submitted, etc. Alternatively, the interaction process may continue in an iterative loop, e.g., by proceeding in the interactive process according to what is shown in FIG. 6b. It can be appreciated that the server AI agent 12 may be instructed to inspect the data input mechanism 20 at various stages, including steps 11/12 to determine if further inputs are needed. It can also be appreciated that while the configuration in FIG. 6a illustrates communications between first and second AI agents 12, 14, the sequences shown may equally apply to a single AI agent 12 positioned in communication with the data input mechanism 20 and having access to the tools 28.

Referring now to FIG. 6b, an additional iterative feedback loop in the interactive process is illustrated. It can be appreciated that the steps shown in FIG. 6b may be initiated at step 12 in FIG. 6a or at any other suitable time where an error, incomplete input, notification, or dynamic change is detected requiring additional data, feedback, instructions, confirmation, etc. If necessary, a handshake may be performed at step 0a and a request for a list of tools may be made at step 0b. At step 1, the server AI agent 12 detects one or more changes to the data input mechanism 20. For example, as discussed above, entry of certain inputs may cause a dynamic webform to change by adding, removing or changing certain interaction elements (e.g., entry fields). At step 2, the server AI agent 12 examines the data input mechanism 20, e.g., via DOM or Accessibility Tree introspection, APIs, or other interfaces. At step 3, the input schema 24 may be updated, e.g., as discussed above, and the updated input schema 24 sent to the client AI agent 14 at step 4.

At step 5, the iterative process may repeat as was shown in FIG. 6a. That is, the client AI agent 14 receives the updated input schema 14 at step 5, determines the tool(s) 28 and/or data required at this iteration at step 6, and prompts the LLM to obtain and return data at step 7. Similarly, the client AI agent 14 receives the data at step 8 and has the input(s) for this iteration entered at step 9.

At step 10a, the server AI agent 12 receives the input(s), which may include tools 28 or an indication of such tools 28, for this iteration, may optionally validate the input(s) at step 10b, and processes those input(s) at step 11. Similar to what was shown in FIG. 6a, step 12 illustrates alternative paths. At step 12a, the server AI agent 12 may determine that the data input mechanism 20 can now be completed (e.g., webform submission, obtain payment token and coordinate with third party, etc.). Alternatively, the interactive process may continue at step 12b, e.g., by repeating the sequence shown in FIG. 6b or proceeding to execute the sequence shown in FIG. 6c.

Referring now to FIG. 6c, it is assumed in this example, that there is at least one input that the AI agents 12, 14 have been unable to determine automatically. For example, information may be missing or manual input may be required for legal or regulatory purposes. If necessary, a handshake may be performed at step 0a and a request for a list of tools may be made at step 0b. At step 1, the server AI agent 12 detects that there is missing information required as at least one input to the data input mechanism 20 (e.g., manual input and/or input from an alternative source). At step 2, the server AI agent 12 may notify the client AI agent 14 of the missing information to activate a "foreground” mode wherein the client AI agent 14 has the user interface 18 expose (e.g., display) the data input mechanism 20 or a portion thereof to have a manual input requested at step 3.

At step 4, the client AI agent 14 may determine if any tools 28 are to be used in obtaining the manual input, e.g., in a semi-automated subprocess and/or to contact and communicate with a third party system (e.g., to obtain payment token, cryptographic credential, etc.). At step 5 the UI 18 may be prompted to obtain and return any data in a manner similar to operations shown in FIGS. 6a and 6b where tools 28 may then be used to enter inputs. At step 5, data is obtained from the user interface 18, e.g., via a manual or otherwise intervened input obtained from an entity such as a user interacting with the user interface 18. At step 6, the client AI agent 14 receives the data obtained at step 5 and has the input(s) entered at step 7.

At step 8a, the server AI agent 12 receives the input(s), may optionally validate the input(s) at step 8b, and process the input(s) at step 9. The server AI agent 12 may take alternative paths at step 10. At step 10a, the data input mechanism 20 may now be completed by obtaining the manual input(s). Alternatively, the server AI agent 12 may determine at step 10b that completion of the data input mechanism 20 requires additional manual intervention, e.g., for payment or to comply with legal or regulatory requirements, etc. In either event, completion of step 10a or 10b in this example results in completion of the data input mechanism 20. It can be appreciated that the sequences shown in FIGS. 6b and 6c may be repeated as many times as required to converge on a completed interactive process. The triggers that initiate such iterations may relate to dynamic changes (e.g., where entry to an interaction element causes a change to a webform), error handling, or other interventions dictated by the data input mechanism 20 or other contextual data associated with the interactive process.

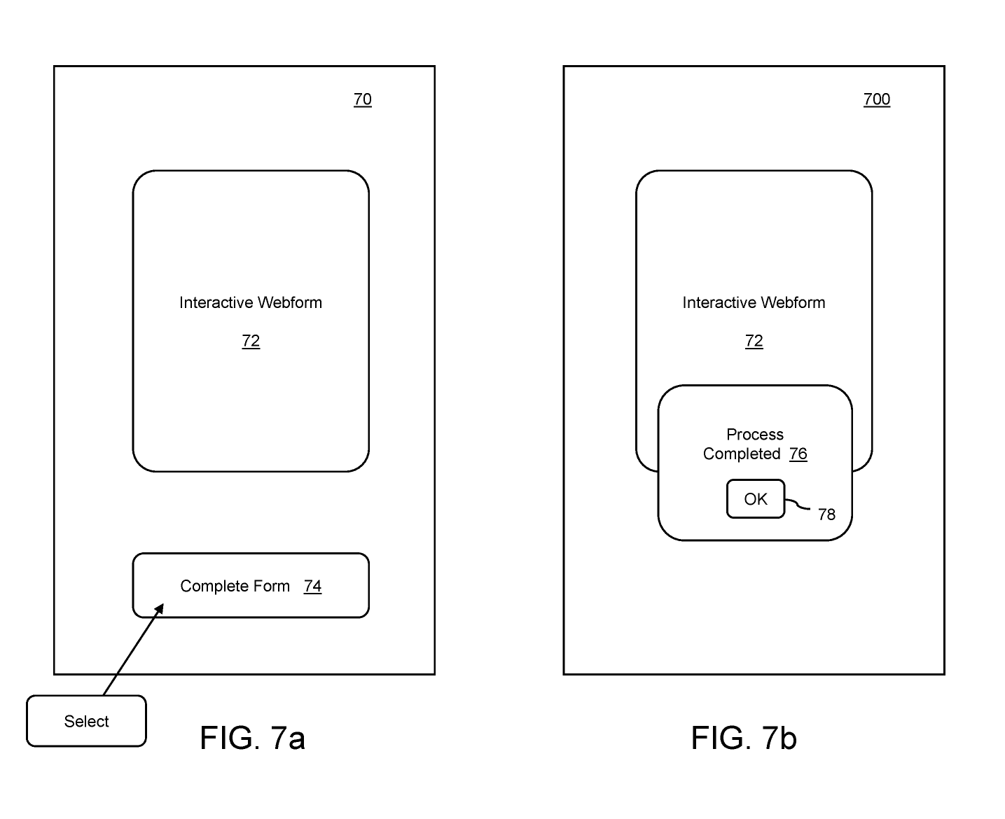

FIGS. 7a and 7b illustrate a user interface 70 having an interactive webform 72, with an option to have it automatically completed. In this example, by selecting a “complete form” button 74 as shown in FIG. 7a, a background process (not shown) may be implemented (e.g., as shown in FIG. 6a) resulting in completion of the interactive webform 72. As illustrated in FIG. 7b, a completion prompt 76 may be displayed to notify the user of successful completion of the interactive webform 72. An “ok” button 78 may be selected to continue.

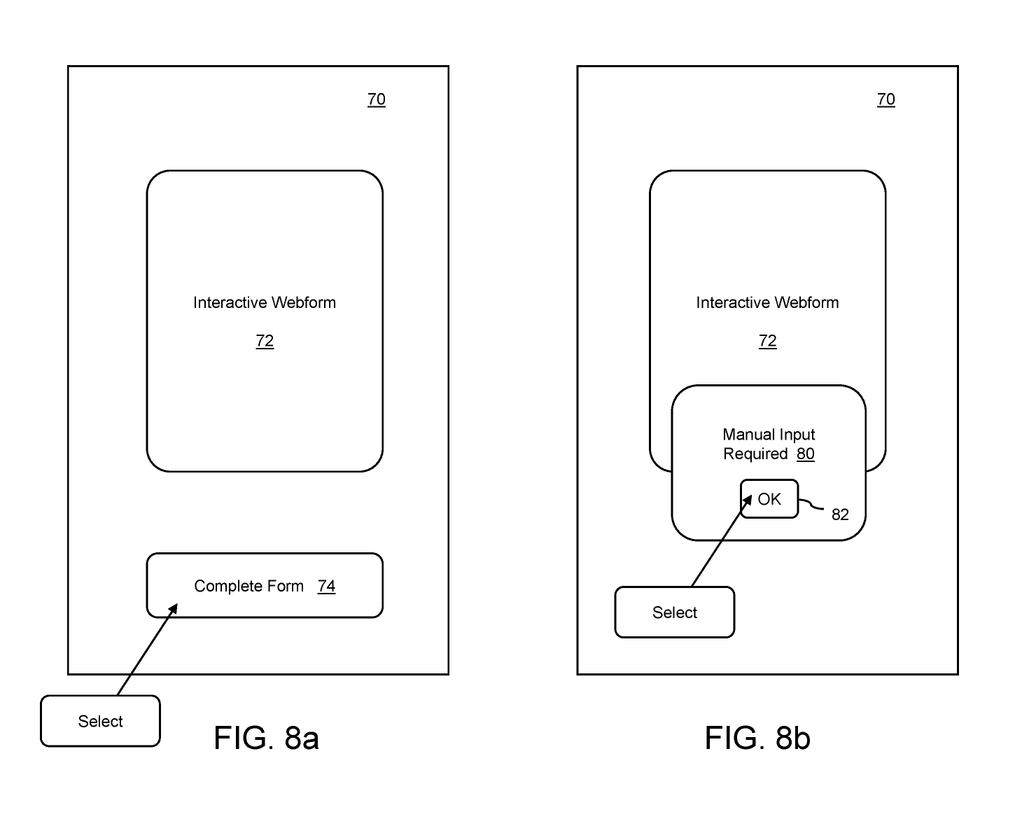

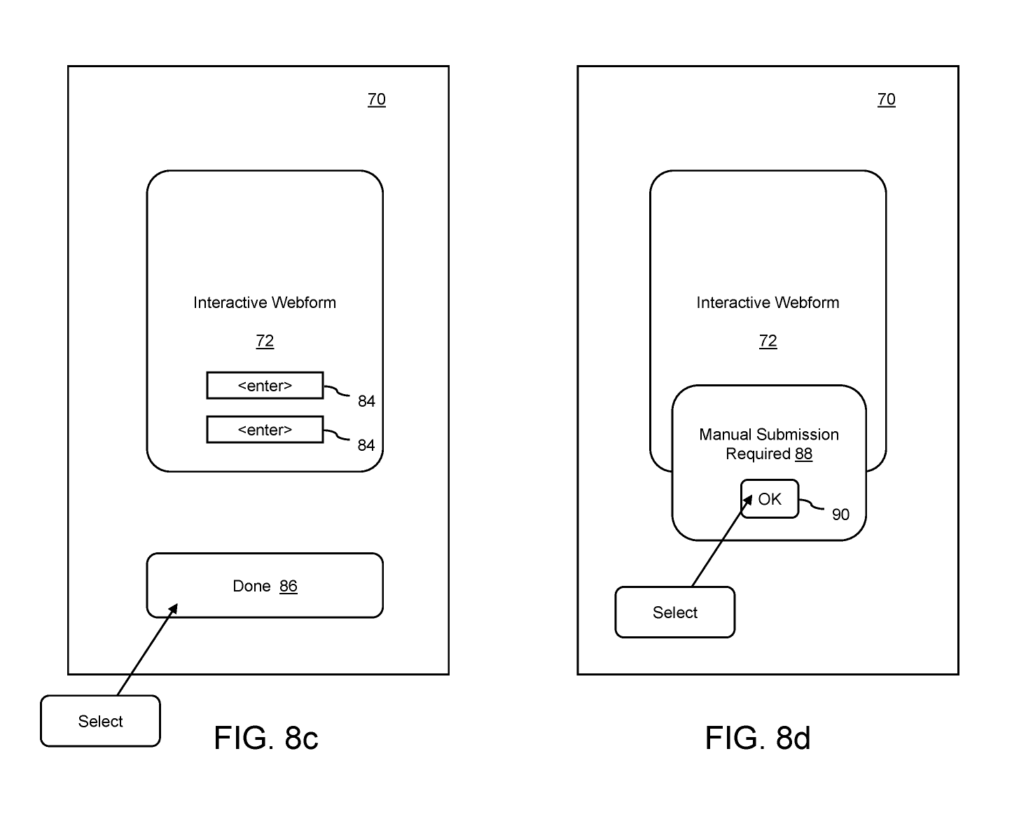

FIGS. 8a, 8b, 8c, and 8d illustrate the user interface 70 having the interactive webform 72, illustrating a prompt for manual input and a prompt for manual submission. Referring first to FIG. 8a, the complete form button 74 may be selected causing a background process (not shown) to be initiated as with FIG. 7a. However, as shown in FIG. 8b, in this scenario, at least one manual input requirement is detected (e.g., as shown in FIG. 6c). A manual input prompt 80 may be displayed and an “ok” button 82 selected as shown in FIG. 8b to proceed with surfacing interaction elements such as entry fields 84 as shown in FIG. 8c. A “done” button 86 may be provided and selected as shown in FIG. 8c to continue with the dynamic interactive process. As shown in FIG. 8d, the process may determine that a manual submission is required (e.g., step 13b in FIG. 6c). An Ok button 90 in a manual submission prompt 88 may be selected as shown in FIG. 8d to initiate a process to have the user finalize the submission. For example a payment process or final “submit” button may be required to complete the interactive webform 72.

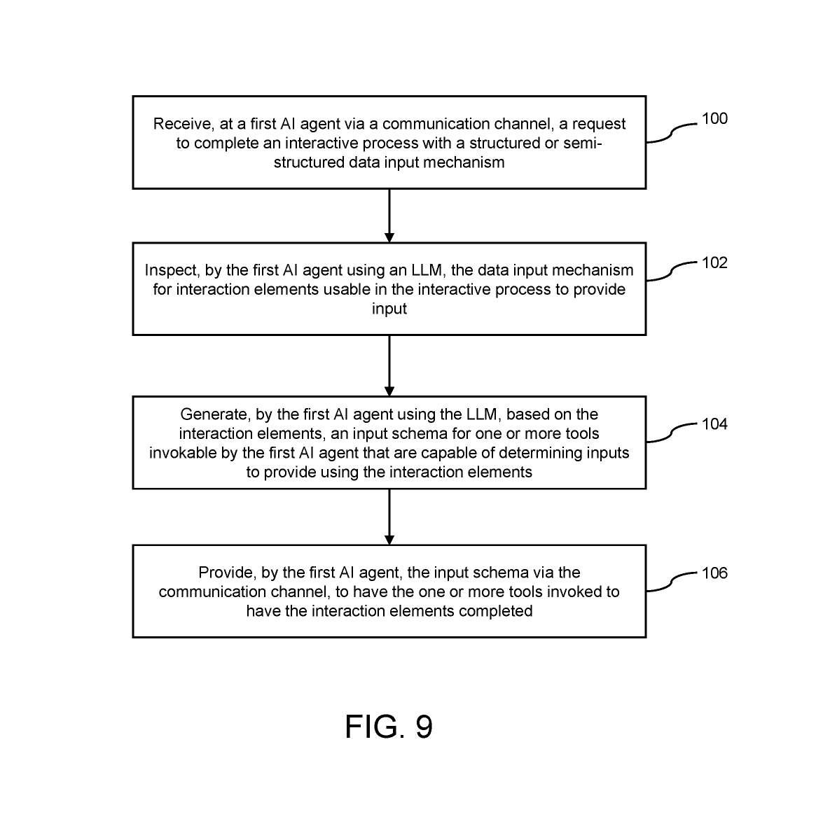

FIG. 9 is a flow chart illustrating example operations for negotiating and executing interactive processes with data input mechanisms 20. At block 100, the first AI agent 12 receives, via the communication channel 16, a request to complete an interactive process with a structured or semi-structured data input mechanism 20 (e.g., step 1 shown in FIG. 6a). At block 102, the first AI agent 12 uses the LLM 22 to inspect the data input mechanism 20 for interaction elements (e.g., entry fields, selectable elements, etc.) that are used in the interactive process such that the first AI agent 12 can provide input(s).

At block 104, the first AI agent 12 uses the LLM 22 to generate, based on the interaction elements, an input schema 24 for tool(s) 28 invokable by the first AI agent 12 (or second AI agent 14). The tool(s) 28 are capable of determining inputs to provide using the interaction elements, e.g., as shown in FIGS. 6a, 6b, and 6c.

At block 106, the first AI agent 12 provides the input schema 24 via the communication channel 16 (e.g., to the second AI agent 14, to the user interface 18, etc.) to have the tool(s) 28 invoked to have the interaction elements completed.

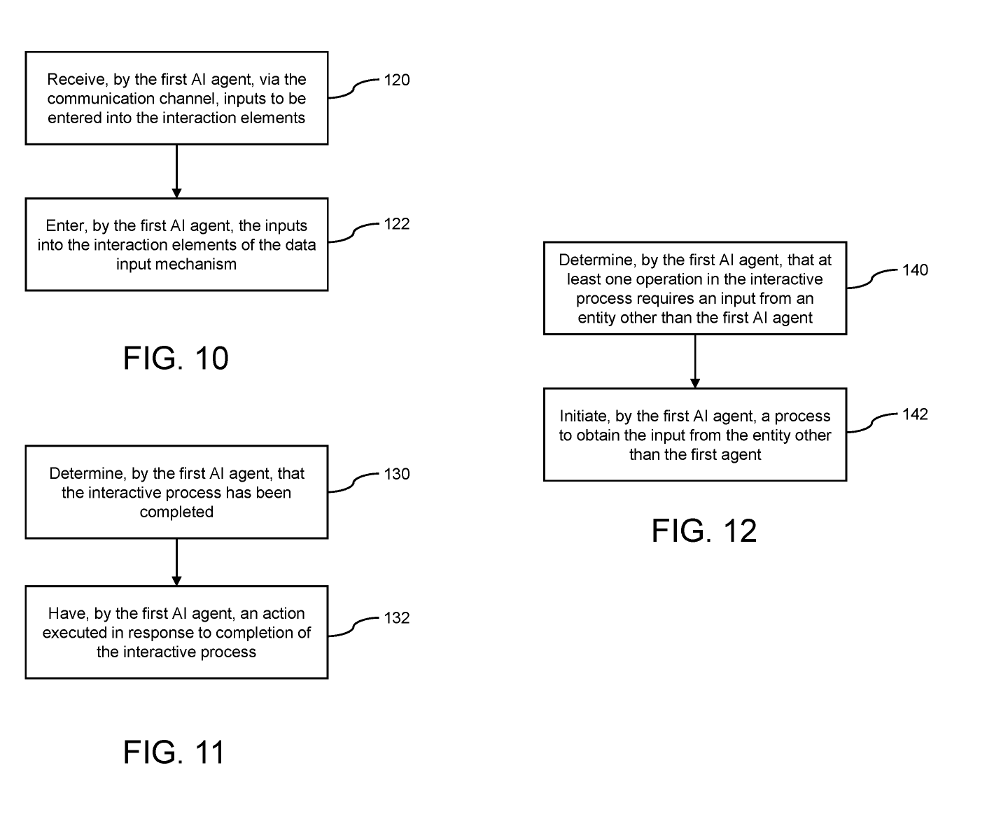

FIG. 10 is a flow chart illustrating example operations for having the first AI agent 12 obtain inputs to be entered into the interaction elements. At block 120, the first AI agent 12 receives input(s) via the communication channel 16 (e.g., from the second AI agent 14, user interface 18, etc.). The received input(s) are to be used to enter data and information into the interaction elements. Thus, at block 122, the first AI agent 12 enters the input(s) into the interaction elements of the data input mechanism 20 (e.g., by entering text in a text box, selecting an option, etc.)

FIG. 11 is a flow chart illustrating example operations for determining completion of an interactive process. At block 130, the first AI agent 12 determines that the interactive process has been completed. At block 132, the system has the first AI agent 12 execute an action in response to completion of the interactive process, e.g., submission of a webform, surfacing for manual completion, etc.

FIG. 12 is a flow chart illustrating example operations for obtaining an input from an entity other than the AI agent 12, 14. At block 140, the first AI agent 12 determines that at least one operation in the interactive process requires an input from another entity (e.g., from a user, third party, etc.). At block 142, the first AI agent 12 may initiate a process to obtain the input from the other entity, e.g., by entering a “foreground” mode, communicating with a third party, etc.

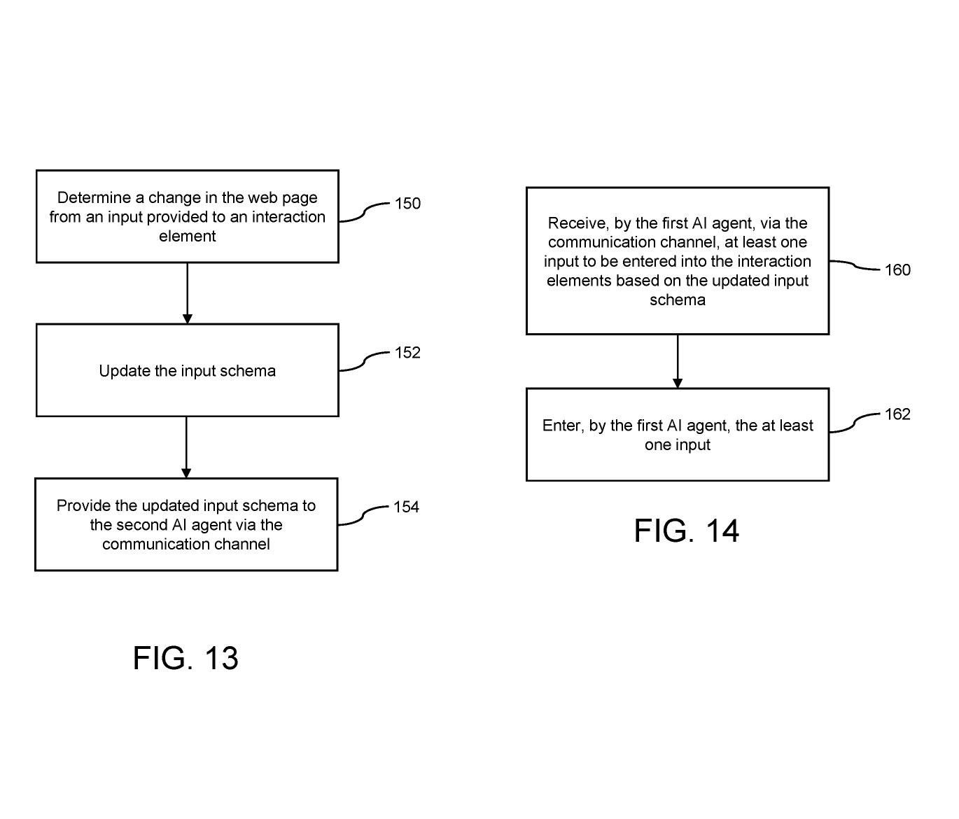

FIG. 13 is a flow chart illustrating example operations for updating an input schema 24 based on changes to a web page. At block 150, the first AI agent 12 determines that a change in the web page has occurred based on an input provided to an interaction element. At block 152, the first AI agent 12 updates the input schema 24 and, at block 154, the updated input schema 24 is provided to, for example, the second AI agent 14 via the communication channel 16.

FIG. 14 is a flow chart illustrating example operations for entering updates based on input received according to an updated input schema 24. At block 160, the first AI agent 12 in this example receives at least one input via the communication channel 16. The input(s) is/are to be entered into interaction elements based on the update input schema 24. At block 162, the first AI agent 12 enters the input(s).

### Neural Networks and Machine Learning

To assist in understanding the present disclosure, some concepts relevant to neural networks and machine learning (ML) are discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), RNNs, and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model’s accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

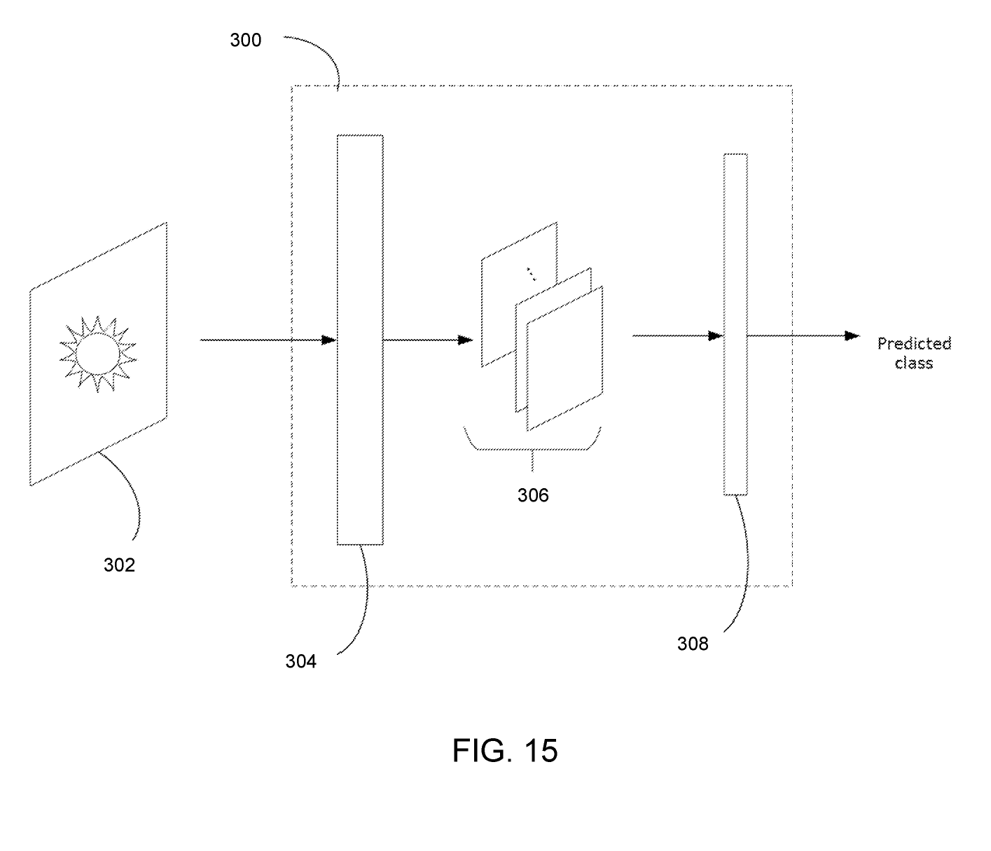

FIG. 15 is a simplified diagram of an example CNN 300, which is an example of a DNN that is commonly used for image processing tasks such as image classification, image analysis, object segmentation, etc. An input to the CNN 300 may be a 2D RGB image 302.

The CNN 300 includes a plurality of layers that process the image 302 in order to generate an output, such as a predicted classification or predicted label for the image 302. For simplicity, only a few layers of the CNN 300 are illustrated including at least one convolutional layer 304. The convolutional layer 304 performs convolution processing, which may involve computing a dot product between the input to the convolutional layer 304 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 304 is a set of feature maps 306 (sometimes referred to as activation maps). Each feature map 306 generally has smaller width and height than the image 302. The set of feature maps 306 encode image features that may be processed by subsequent layers of the CNN 300, depending on the design and intended task for the CNN 300. In this example, a fully connected layer 308 processes the set of feature maps 306 in order to perform a classification of the image, based on the features encoded in the set of feature maps 306. The fully connected layer 308 contains learned parameters that, when applied to the set of feature maps 306, outputs a set of probabilities representing the likelihood that the image 302 belongs to each of a defined set of possible classes. The class having the highest probability may then be outputted as the predicted classification for the image 302.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs 18.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of an LLM 18 may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

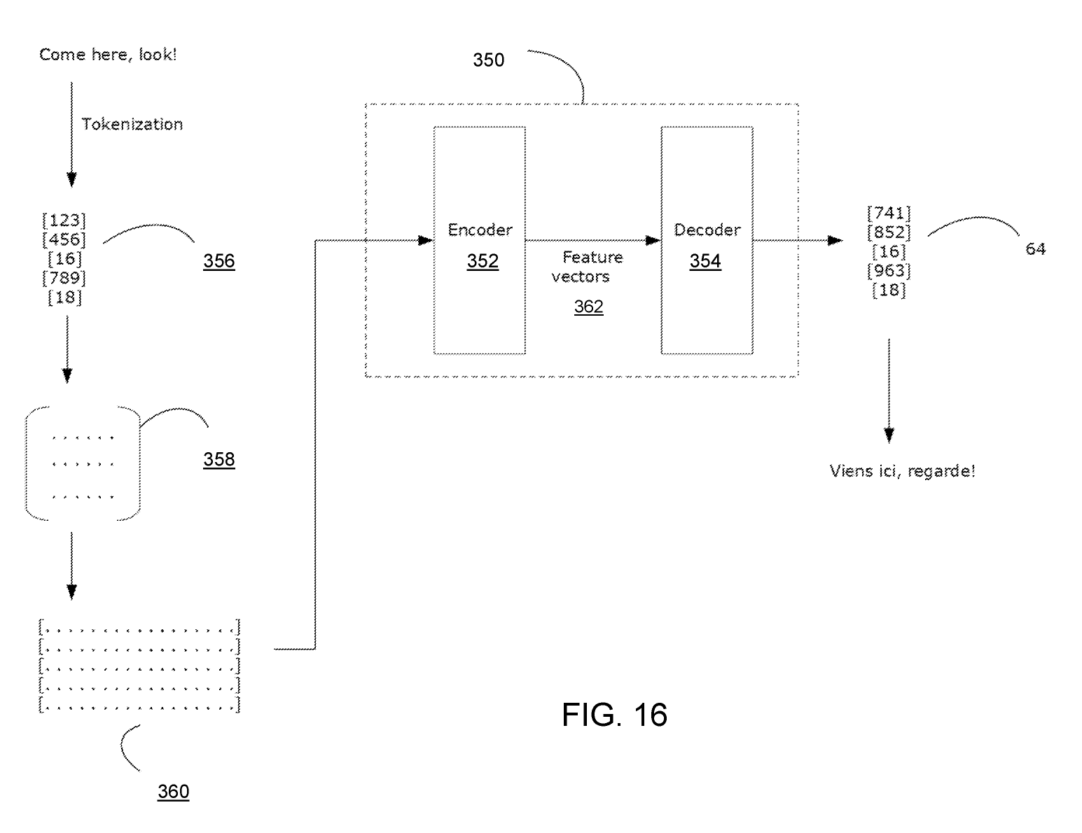

FIG. 16 is a simplified diagram of an example transformer 350, and a simplified discussion of its operation is now provided. The transformer 350 includes an encoder 352 (which may comprise one or more encoder layers/blocks connected in series) and a decoder 354 (which may comprise one or more decoder layers/blocks connected in series). Generally, the encoder 352 and the decoder 354 each include a plurality of neural network layers, at least one of which may be a self-attention layer. The parameters of the neural network layers may be referred to as the parameters of the language model.

The transformer 350 may be trained on a text corpus that is labelled (e.g., annotated to indicate verbs, nouns, etc.) or unlabelled. LLMs 18 may be trained on a large unlabelled corpus. Some LLMs 18 may be trained on a large multi-language, multi-domain corpus, to enable the model to be versatile at a variety of language-based tasks such as generative tasks (e.g., generating human-like natural language responses to natural language input).

An example of how the transformer 350 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 16, a short sequence of tokens 356 corresponding to the text sequence “Come here, look!” is illustrated as input to the transformer 350. Tokenization of the text sequence into the tokens 356 may be performed by some preprocessing tokenization module such as, for example, a byte pair encoding tokenizer (the “pre” referring to the tokenization occurring prior to the processing of the tokenized input by the LLM 18), which is not shown in FIG. 16 for simplicity. In general, the token sequence that is inputted to the transformer 350 may be of any length up to a maximum length defined based on the dimensions of the transformer 350 (e.g., such a limit may be 2048 tokens in some LLMs 18). Each token 356 in the token sequence is converted into an embedding vector 360 (also referred to simply as an embedding). An embedding 360 is a learned numerical representation (such as, for example, a vector) of a token that captures some semantic meaning of the text segment represented by the token 356. The embedding 360 represents the text segment corresponding to the token 356 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 360 corresponding to the “look” token will be closer to another embedding corresponding to the “see” token in the vector space, as compared to the distance between the embedding 360 corresponding to the “look” token and another embedding corresponding to the “cake” token. The vector space may be defined by the dimensions and values of the embedding vectors. Various techniques may be used to convert a token 356 to an embedding 360. For example, another trained ML model may be used to convert the token 356 into an embedding 360. In particular, another trained ML model may be used to convert the token 356 into an embedding 360 in a way that encodes additional information into the embedding 360 (e.g., a trained ML model may encode positional information about the position of the token 356 in the text sequence into the embedding 360). In some examples, the numerical value of the token 356 may be used to look up the corresponding embedding in an embedding matrix 358 (which may be learned during training of the transformer 350).

The generated embeddings 360 are input into the encoder 352. The encoder 352 serves to encode the embeddings 360 into feature vectors 362 that represent the latent features of the embeddings 360. The encoder 352 may encode positional information (i.e., information about the sequence of the input) in the feature vectors 362. The feature vectors 362 may have very high dimensionality (e.g., on the order of thousands or tens of thousands), with each element in a feature vector 362 corresponding to a respective feature. The numerical weight of each element in a feature vector 362 represents the importance of the corresponding feature. The space of all possible feature vectors 362 that can be generated by the encoder 352 may be referred to as the latent space or feature space.

Conceptually, the decoder 354 is designed to map the features represented by the feature vectors 362 into meaningful output, which may depend on the task that was assigned to the transformer 350. For example, if the transformer 350 is used for a translation task, the decoder 354 may map the feature vectors 362 into text output in a target language different from the language of the original tokens 356. Generally, in a generative language model, the decoder 354 serves to decode the feature vectors 362 into a sequence of tokens. The decoder 354 may generate output tokens 364 one by one. Each output token 364 may be fed back as input to the decoder 354 in order to generate the next output token 364. By feeding back the generated output and applying self-attention, the decoder 354 is able to generate a sequence of output tokens 364 that has sequential meaning (e.g., the resulting output text sequence is understandable as a sentence and obeys grammatical rules). The decoder 354 may generate output tokens 364 until a special [EOT] token (indicating the end of the text) is generated. The resulting sequence of output tokens 364 may then be converted to a text sequence in post-processing. For example, each output token 364 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs 18. An example GPT-type LLM 18 is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM 18, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an API). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM 18 may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM 18 may be referred to as a prompt, which is a natural language input that includes instructions to the LLM 18 to generate a desired output. A computing system may generate a prompt that is provided as input to the LLM 18 via its API. As described above, the prompt may optionally be processed or preprocessed into a token sequence prior to being provided as input to the LLM 18 via its API. A prompt can include one or more examples of the desired output, which provides the LLM 18 with additional information to enable the LLM 18 to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, any entity within the computing environment 10 such as the local system 38, remote server 36, web server 40, agent provider 42 and/or other computing devices; any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

What is claimed is:

1. A computer-implemented method comprising:
receiving, at a first computer-implemented artificial intelligence (AI) agent via a communication channel, a request to complete an interactive process with a structured or semi-structured data input mechanism;
inspecting, by the first AI agent using a large language model (LLM), the data input mechanism for interaction elements usable in the interactive process to provide input;
generating, by the first AI agent using the LLM, based on the interaction elements, an input schema for one or more tools invokable by the first AI agent that are capable of determining inputs to provide using the interaction elements; and
providing, by the first AI agent, the input schema via the communication channel, to have the one or more tools invoked to have the interaction elements completed.

2. The method of claim 1, further comprising:
receiving, by the first AI agent, via the communication channel, inputs to be entered into the interaction elements; and
entering, by the first AI agent, the inputs into the interaction elements of the data input mechanism.

3. The method of claim 2, further comprising:
determining, by the first AI agent, that the interactive process has been completed; and
having, by the first AI agent, an action executed in response to completion of the interactive process.

4. The method of claim 1, further comprising:
determining, by the first AI agent, that at least one operation in the interactive process requires an input from an entity other than the first AI agent; and
initiating, by the first AI agent, a process to obtain the input from the entity.

5. The method of claim 4, wherein the input from the entity includes obtaining confirmation of completion of a submission.

6. The method of claim 5, wherein the input is obtained via a user interface operable to utilize the first AI agent.

7. The method of claim 1, wherein the input schema defines inputs to be determined using one or more tools from a set of tools.

8. The method of claim 1, wherein the input schema provides a mapping to a dynamic set of tools capable of determining the inputs.

9. The method of claim 1, wherein the request is received from, and the input schema is provided to, a second AI agent.

10. The method of claim 9, wherein the second AI agent utilizes an LLM.

11. The method of claim 10, wherein the communication channel provides structured communications to provide inputs to the LLMs, using a context-based protocol.

12. The method of claim 11, wherein the context-based protocol incorporates contextual data into the structured communications.

13. The method of claim 12, wherein the contextual data includes tool calls.

14. The method of claim 12, wherein the context-based protocol is Model Context Protocol (MCP).

15. The method of claim 1, wherein the first AI agent is running on a local computer system, the data input mechanism being provided to the local computer system by a remote server.

16. The method of claim 9, wherein the first AI agent is running on a remote server and the second AI agent is running on a local computer system, the communication channel connecting the remote server and the local computer system via a communications network.

17. The method of claim 9, wherein the first AI agent and the second AI agent are provided by an agent provider operable between a remote server and a local computer system providing a user interface in communication with the second AI agent.

18. The method of claim 1, wherein the data input mechanism includes a web page.

19. The method of claim 18, wherein the web page is inspected to determine the interaction elements using document object model (DOM) introspection.

20. The method of claim 1, wherein the data input mechanism is inspected via an application programming interface (API) utilized by the first AI agent.

21. The method of claim 18, further comprising:
determining a change in the web page from an input provided to an interaction element;
updating the input schema; and
providing the updated input schema to the second AI agent via the communication channel.

22. The method of claim 21, further comprising:
receiving, by the first AI agent, via the communication channel, at least one input to be entered into the interaction elements based on the updated input schema; and
entering, by the first AI agent, the at least one input.

23. The method of claim 21, wherein entering an input to one of the interaction elements causes a dynamic change to the web page.

24. The method of claim 23, wherein the change in the web page is caused by progressing from a first webform to a second webform used in completing the interactive process.

25. The method of claim 1, wherein at least one input is obtained by processing a token.

26. The method of claim 25, further comprising using the token to obtain the at least one input from a third party.

27. The method of claim 3, wherein the data input mechanism includes a web page and the action comprises submitting a completed webform.

28. A computer system comprising:
a processor; and
a memory, the memory storing processor executable instructions that, when executed by the processor, cause the computer system to:
receive, at a first computer-implemented artificial intelligence (AI) agent via a communication channel, a request to complete an interactive process with a structured or semi-structured data input mechanism;
inspect, by the first AI agent using a large language model (LLM), the data input mechanism for interaction elements usable in the interactive process to provide input;
generate, by the first AI agent using the LLM, based on the interaction elements, an input schema for one or more tools invokable by the first AI agent that are capable of determining inputs to provide using the interaction elements; and
provide, by the first AI agent, the input schema via the communication channel, to have the one or more tools invoked to have the interaction elements completed.

29. A computer-readable medium storing processor executable instructions that, when executed by a processor of a computer system, cause the computer system to:
receive, at a first computer-implemented artificial intelligence (AI) agent via a communication channel, a request to complete an interactive process with a structured or semi-structured data input mechanism;
inspect, by the first AI agent using a large language model (LLM), the data input mechanism for interaction elements usable in the interactive process to provide input;
generate, by the first AI agent using the LLM, based on the interaction elements, an input schema for one or more tools invokable by the first AI agent that are capable of determining inputs to provide using the interaction elements; and
provide, by the first AI agent, the input schema via the communication channel, to have the one or more tools invoked to have the interaction elements completed.
